(19) United States
(12) Patent Application Publication
(10) Pub. No.: US 2012/0185398 A1
(43) Pub. Date: Jul. 19, 2012

(54) MOBILE PAYMENT SYSTEM WITH TWO-POINT AUTHENTICATION

(76) Inventors: Meir Weis, Calgary (CA); Igor Elisman, Brooklyn, NY (US)

(21) Appl. No.: 13/496,931

(22) PCT Filed: Sep. 10, 2010
(86) PCT No.: PCT/CA2010/001414

§ 371 Date: Mar. 19, 2012

Related U.S. Application Data
(60) Provisional application No. 61/243,253, filed on Sep. 17, 2009.

(51) Int. Cl. G06Q 20/12; H04L 9/32

(52) U.S. Cl. 705/75; 705/16

(57) ABSTRACT

A transaction processing system uses a mobile phone to make payments at point of sale (POS), over the internet, and over the phone, and also to make money transfers. Transaction security is provided by using various combinations of authentication using the mobile phone. Account numbers linked to payment cards, and public/private keys that encrypt/decrypt customer data, dynamically change on mobile phone and a server, based on a specified number of transactions or time interval. No credit/debit account information is shown on mobile phones. GPS location and time stamps facilitate identification of unusual shopping patterns during internet and over-the-phone transactions. Customers can remotely delete data on mobile phone in case of loss. Three-level security used at POS combines industry-standard encryption; dynamically-changing account numbers and keys; and visual identification of customer, followed by software signature recognition.

### FIELD OF THE INVENTION

The present invention relates in general to methods and systems for conducting financial transactions over computer networks, and relates in particular to such methods and systems incorporating the use of mobile devices such as cellular telephones, personal digital assistants (PDAs), and laptop computers.

### BACKGROUND OF THE INVENTION

Various methods of electronic commerce (or “E-commerce”) have been in use since the 1980s for conducting financial transactions over computer networks such as the Internet. Examples of such known E-commerce methods include electronic retailing (“E-tailing”), online shopping, and electronic funds transfer. Some E-commerce methods and systems use mobile devices such as cellular telephones; such methods are alternatively referred to as mobile commerce (“M-commerce”) methods. M-commerce has been used for financial transactions including payments for vending machines, parking charges, airline tickets, and location-based services (LBS).

For purposes of this patent document, the term “mobile payment system” will be used as an alternative reference to M-commerce, and is to be broadly understood as including but not being limited to the examples given immediately above. As well, the term “mobile phone” is to be broadly interpreted as including but not being limited to cellular telephones, PDAs, and wirelessly-enabled laptop computers.

As mobile devices become more sophisticated and more widely used, the practical uses for M-commerce can be expected to expand exponentially, along with the demand for such technologies. Such growth can also be expected to generate increased concern for security and protection of personal information used in M-commerce. Accordingly, there is a need for mobile payment methods and systems that provide greater and more reliable security than currently available.

### BRIEF SUMMARY OF THE INVENTION

Provided in accordance with the present invention are embodiments of transaction processing systems that use mobile phones as a means for making payments and money transfers. For purposes of this patent document, the abbreviation “MPS” (or, alternatively, “LS-MPS” in some instances, including in the drawings) will be used in reference to mobile payment systems in accordance with the present invention.

MPS in accordance with various embodiments of the invention can be used for payments at point of sale (POS), over the Internet, and over the phone. MPS may used to make customer-to-customer money transfers and bank-to-customer money transfers. MPS provides enhanced security for customers' confidential information. MPS can co-exist with or replace current payment systems, and can also be adapted to integrate future payment and transfer transactional processing technologies.

MPS is modular system, and in its various embodiments may comprise modules which for purposes of this patent document are defined and referred to as follows:

MPS MPA: Mobile Phone Application.

MPS Web: Web site for registration, account modification and transaction viewing.

MPS POI: Payment Over Internet module.

MPS POP: Payment Over Phone module.

MPS POS: POS (Point of Sale) stand-alone software or plug-in into third-party POS software.

MPS MTM: Money Transfer Module.

MPS PID: POS Interface Device—an input payment device that acts as transaction processor between MPS POS with third-party POS software and MPS Server. MPS PID is extendible by using modular architecture such that it will accept existing and future-developed payment input modules with a magnetic swipe reader and barcode reader installed as initial modules, with options to attach RFID (Radio-Frequency Identification), NFC (Near Field Communication), NSDT (Near Sound Data Transfer) as additional payment modules.

MPS BIL: Bank Interface Library—a library for establishing communication between banks and MPS Server.

MPS Server Handles all transactions between Mobile Phone, MPS MPA, MPS PID, MPS POS, MPS Web, MPS POI, MPS POP, MPS MTM, and MPS BIL modules.

Methods of security which may be used with MPS in accordance with the present invention are summarized below:
Mobile phone is used as a confirmation medium for registration of accounts, as well as for interne and over-the-phone payments. Security methods referred to as “two-point dynamic solutions” allow various combinations of authentication using a mobile phone where each solution is based on a combination of levels of security, while be simple to use.
Account numbers linked to an actual account of a payment card (e.g., credit card or debit card) dynamically change on mobile phones and server, based on certain number of transactions or certain time interval.
Public/private keys that encrypt and decrypt customer's data dynamically change on mobile phones and server, based on certain number of transaction or certain time interval.
POS modules allow personnel at POS to identify customers visually.
POS modules allow usage of signature recognition software for customer identification
No credit/debit account information is shown on mobile phones—only account description.
GPS location and time stamps facilitate identification of unusual shopping patterns during internet and over-the-phone transactions, since most online and over-the-phone shopping is done from common locations.
Customer has the ability to remotely delete sensitive data on his or her mobile phone if it is lost, with automatic notification to customer support.

At Point Of Sale, highest levels of security is achieved and identified as Three Levels of Security or TLS:
1^{st} level: industry standard encryption.
2^{nd} level: dynamically-changing account numbers and keys per account; no actual account number on the phone; phone is used as confirmation tool; location-based determination.
3^{rd} level: visual identification of customer at POS either by personnel or software, followed by software signature recognition.

In the event that the first two levels are broken by an intruder, visual identification along with signature recognition will ensure that the customer is the person he or she claims to be.

MPS is a modular payment system. It allows acceptance of different input/output transaction modules on hardware and software levels. MPS PID is a hardware device that can accept existing and new payment input modules using standard ports, and it functions independently of third-party POS software and hardware. MPS POS is software that can be used as plug-in to third-party POS suites or as standalone suite with plug-in architecture, allowing developers to create new functionalities. MPS will accept existing technology such as magnetic card swipe devices, as well contact-less technology such as RFID, NFC and NSDT.

MPS uses a form of barcode payment at POS. Payment/credit accounts such as credit/debit cards, bank accounts, internet accounts, transportation cards, student cards, franchise cards, etc., are presented in a form of barcode on the phone screen. A mobile phone application will generate a matrix barcode on the phone screen to ensure that it is correctly shown based on screen dimensions. Matrix barcodes can be presented as QR barcodes, Aztec barcodes, and others. For simplest transactions, regular linear barcodes can be used. A CCD (charge-coupled device) representing a regular digital camera scans barcode from the phone screen and transfers scanned data for processing to POS. The CCD device is integrated into MPS PID, and used as a standalone CCD device such as a CCD scanner in MPS POS. Benefits provided by this barcode solution may include:
Phone manufacturers do not have to modify mobile phones' hardware to accommodate barcode payments.
Card production costs and card material consumption is reduce because the need for card replacement is lessened.
Improved security reduces theft and fraud, and banks can create their own virtual cards without using brand name cards.
Advertisements can be delivered directly to mobile phones using various methods, such as by integrating scanning of barcode coupons with barcode payments.
For online payment authorities where customer credit accounts only allow online payments, barcodes representing those accounts on mobile phones allow purchases from such accounts at physical locations such as malls, restaurants, etc.
Customers can keep all accounts and coupons in one place protected by a “pin” that they know. Those accounts can be credit/debit cards, bank accounts, gift certificates, transportation cards, student cards, venue tickets, etc. In case mobile phone is stolen, data can be automatically and remotely erased from the phone. If lost phone is located, all credit accounts can be electronically redelivered.

### BRIEF DESCRIPTION OF THE DRAWINGS

Embodiments of the invention will now be described with reference to the accompanying Figures, in which numerical references denote like elements, and in which:

FIG. 1 is a schematic illustration of the modules of a Mobile Payment System (MPS) in accordance with one embodiment of the present invention.

FIG. 2 is a schematic illustration of the Custom Registration Process of an MPS in accordance with one embodiment of the invention.

FIG. 3 illustrates technical details of the Custom Registration Process of FIG. 2.

FIG. 4 is a logic diagram/flow chart for the App Store Registration Process of an MPS in accordance with one embodiment of the invention.

FIG. 5 is a logic diagram/flow chart for the App Store Registration Process of FIG. 4, illustrating the process for registering credit accounts.

FIG. 6 conceptually illustrates the use of barcodes in conjunction with bank cards and mobile phones using MPS in accordance with embodiments of the present invention.

FIG. 7 conceptually illustrates the transfer of a barcode corresponding to a selected bank card, from a mobile phone at Point of Sale (POS).

FIG. 8 conceptually illustrates picture identification at POS.

FIG. 9 conceptually illustrates cashier approval at POS after confirmation of picture ID.

FIG. 10 is a logic diagram/flow chart of the process of making a barcode payment via mobile phone using MPS in accordance with an embodiment of the present invention.

FIG. 11 is a logic diagram/flow chart of the payment process at POS using either MPS POS or MPS PID modules, in accordance with an embodiment of the present invention.

FIG. 12 conceptually illustrates a mobile authorization procedure in accordance with an embodiment of MPS.

FIG. 13 illustrates mobile authentication as in FIG. 12 preceded by Web authentication.

FIG. 14 illustrates mobile authentication as in FIG. 12 preceded by voice authentication.

FIG. 15 conceptually illustrates a mobile authentication procedure using an encrypted confirmation number and key received in SMS (Short Message Service) using a mobile phone's Web browser, in accordance with an embodiment of MPS.

FIG. 16 illustrates mobile authentication as in FIG. 15 preceded by Web authentication.

FIG. 17 illustrates mobile authentication as in FIG. 15 preceded by voice authentication.

FIG. 18 conceptually illustrates a mobile authentication procedure via mobile phone application with SMS confirmation, public key, and dynamic account exchanges, in accordance with an embodiment of MPS.

FIG. 19 illustrates mobile authentication as in FIG. 18 preceded by Web authentication.

FIG. 20 illustrates mobile authentication as in FIG. 18 preceded by voice authentication.

FIG. 21 conceptually illustrates a mobile authentication procedure via a mobile phone application with Web confirmation, public key, and dynamic account exchanges, in accordance with an embodiment of MPS.

FIG. 22 illustrates mobile authentication as in FIG. 21 preceded by Web authentication.

FIG. 23 illustrates mobile authentication as in FIG. 21 preceded by voice authentication.

FIG. 24 conceptually illustrates a mobile authentication procedure generally as in FIG. 21 using a Payment-Over-Internet (POI) module in accordance with an embodiment of MPS.

FIG. 25 is a logic diagram/flow chart of the mobile authentication procedure of FIG. 24.

FIG. 26 conceptually illustrates a mobile authentication procedure generally as in FIG. 21 using a Payment-Over-Phone (POP) module in accordance with an embodiment of MPS.

FIG. 27 is a logic diagram/flow chart of the mobile authentication procedure of FIG. 26.

FIG. 28 conceptually illustrates an MPS Web module in accordance with an embodiment of MPS.

FIG. 29 is a logic diagram/flow chart of the mobile authentication procedure of FIG. 28.

FIG. 30 conceptually illustrates a Money Transfer Module (MTM) in accordance with an embodiment of MPS, used to transfer money between bank accounts.

FIG. 31 conceptually illustrates an MTM in accordance with an embodiment of MPS, used to transfer money between phone accounts.

FIG. 32 schematically illustrates the server hardware architecture required to run MPS Servers in accordance with an embodiment of the present invention.

### DETAILED DESCRIPTION OF THE PREFERRED EMBODIMENT

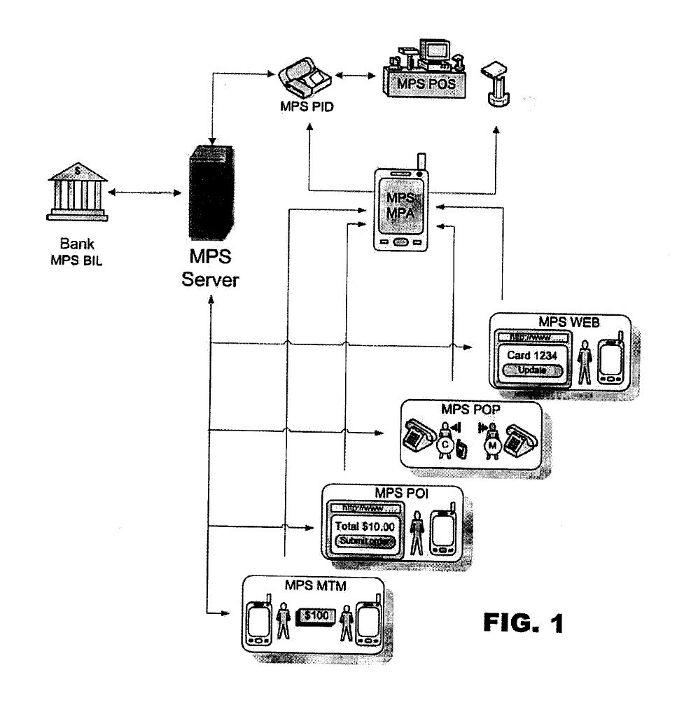

FIG. 1 conceptually illustrates how various MPS modules interact with each other.

### MPS Dynamic Security

In accordance with one embodiment, MPS incorporates a dynamic security system, using two-point dynamic solutions, dynamic account number regeneration, visual identification, and three levels of security. In accordance with the two-point authentication system, the authentication process occurs in two different locations. A first authentication identified by a customer's credentials occurs at one location, and is followed by an additional authentication made using a mobile phone in another location.

During the process of two-point authentication, MPS security is enhanced by using dynamic passwords. This occurs during application registration, accounts modification, and transaction processing. For purposes of this patent document, a dynamic password is alternatively referred as a “one-time PIN (personal ID number)” or an OTP.

MPS uses scenarios where an OTP is created or generated in one location, and then used in conjunction with a static password or another dynamic password at a different location to encrypt or decrypt required information.

### Two-Point Dynamic Solutions

MPS may employ any of several different methods of two-point authentication using dynamic passwords (OTPs); these methods may be referred to for convenience as “Two-Point Dynamic Solutions”. The appropriate method for a given MPS application will depend on security requirements. Examples of two-point authentication systems in accordance embodiments of the invention are described below:

### Example #1

OTP is created manually by the customer/user. An image representing a random number is automatically generated and shown. OTP and image are created at a first location will encrypt required data, which is transferred from the first location to a second location. OTP along with random image are re-entered at confirmation stage to decrypt data at the second location.

This is the most secure authentication method used in MPS, since the OTP created by the user and the generated random number shown as image represent a unique combination of two different techniques involving two random events. This creates a major obstacle for any person attempting to retrieve desired information. This method also does not use static passwords, and therefore does not expose any.

To provide a practical example, Point 1 is defined as a Web site where a user authenticates his or her identity, while Point 2 is a mobile phone. User creates an OTP at Point 1, whereupon a server generates a random number and outputs it as image on the Web. Data encrypted by OTP and image is transferred from Web to mobile phone. User uses the OTP and random image number to decrypt data transferred from the Web (Point 1) to the mobile phone (Point 2).

In a variant of this method, OTP or the random number image are transferred in encrypted form from Point 1 to Point 1.

### Example #2

OTP is created manually by customer. OTP created at first location and static password will encrypt required data. Encrypted data is transferred from first location to second location. OTP along with static key/password is manually re-entered at confirmation stage to decrypt data at second location.

As an example, point one is Web site where user authenticates his identity, while point two is mobile phone where user uses the same OTP and static password to decrypt data transferred from point one to point two. Security of this method is very high overall but lower if comparing to method 1 because it exposes static password. This method however requires fewer steps for customers to authenticate themselves than in method 1 since user does not need to view image every time transaction occurs. Hybrid of this method is when OTP or static password is transferred between two points in encrypted form. However, hybrid is less secure since OTP or static password if intercepted can be exposed.

### Example #3

OTP is generated automatically and shown as image. OTP generated at first location and static password will encrypt required data. Encrypted data is transferred from first location to second location. OTP along with static key/password is manually re-entered at confirmation stage to decrypt data at second location.

As an example, point one is Web site where user authenticates his identity, while point two is mobile phone where user uses the same OTP and static password to decrypt data transferred from point one to point two. Security of this method is very high overall but lower if comparing to method 2 because it exposes static password and image shown. This method however requires fewer steps for customers to authenticate themselves than in method 2 since users do not need to create OTP every time transaction occurs. Hybrid of this method is when OTP or static password is transferred between two points in encrypted form. However, hybrid is less secure since OTP or static password if intercepted can be exposed. Methods similar to method 3 have been implemented in systems other than MPS as well.

### Example #4

OTP is created manually by customer or automatically shown as image. Confirmation key is random number and created automatically. Created OTP and generated confirmation key at first location will encrypt required data. Encrypted data is transferred from first location to second location. Confirmation key is transferred from first location to second location using different transport method that was used to transfer encrypted data. OTP along with confirmation key are manually re-entered at confirmation stage to decrypt data at second location. Part of decrypted data will be used to manually finish transaction in location one.

Current method is less secure than methods 1-3 because confirmation key is exposed. This method is very specific to mobile phone use where there are different data delivery methods such as http and SMS protocols. For example, encrypted data is transferred over http and confirmation key is transferred via SMS. In case OTP was created automatically and shown as image, image is exposed lowering security.

### Example #5

OTP is created manually by customer or automatically shown as image or automatically created and stored in background at location one. Public key encrypts OTP and transfers encrypted OTP from first to second location. At second location, OTP is decrypted by private key and random confirmation key is automatically generated. OTP and confirmation key encrypt data at second location. Encrypted data is transferred from second location to first location. Confirmation key is transferred from second location to first location using different transport method that was used to transfer data. OTP is re-entered manually at location one if created manually or was shown as image or re-entered automatically if was stored in background. Confirmation key is entered manually at location one. Both OTP and confirmation key will decrypt data. Part of decrypted data will be used to manually finish transaction in location two.

Current method is very specific method for authentication using mobile phones. It is used to create request from mobile phones and receive back encrypted data. Confirmation number is exposed as well as encrypted OTP during transmission. This method is most secure when OTP is created by customer, then security lowers when image is used and it is the lowest when OTP is stored in background and re-entered from background at confirmation stage. In this case, background OTP creation requires fewest steps for customer to perform and manual OTP creation requires most steps to be performed, while image creation stands in between in terms above in terms of steps to perform.

### Example #6

Request data from authenticated location one. Generate automatically random confirmation key and encrypt data with it at location two. Transfer encrypted data from second to first location. Transfer confirmation key from second to first location using different delivery method that the one used to transfer encrypted data. Enter confirmation key to decrypt data. Part of decrypted data will be used to manually finish transaction in location two.

This method is specifically used in mobile phones to request specific data. It is low in terms of security because dynamic data which is confirmation key is unencrypted, so if exposed, data can be easily decrypted; however security is higher than security of using static passwords.

### Example #7

Unencrypted confirmation number is generated randomly and sent from location one to location two automatically. Confirmation number received in location two will be manually re-entered in location one.

This method is lowest in security comparing to all other methods since if unencrypted confirmation number is exposed, intruder will gain access to transaction. Method has fewest steps that all other methods. This method commonly used in other systems.

### Example #8

Create transaction at authenticated location one that will be stored on server. At authenticated location two, request description of transaction made at location one along with confirmation key. Receive confirmation key into location two and re-enter it at location two to verify location one's transaction.

This method can be used for transactions on interne and over the phone. As an example, customer will make a purchase on the Web site and transaction details of purchase will be stored on server. Using mobile phone, customer will request a list of open Web transactions from the server to be confirmed with confirmation number generated per each transaction. In mobile phone, per each entry of list, there will be transaction description, corresponding confirmation number in form of image and textbox to reenter that confirmation number. Customer will select desired transaction on mobile phone and by looking confirmation number in an image will type that into confirmation textbox. Confirmation number entered along with transaction chosen will be encrypted and signed by public key and send to server. Server will decrypt data received from phone using private key and verify if confirmation number received from phone matches stored on server. If numbers do match, transaction will be approved. It is a secure method since authentications are distinct from one another and sensitive data is encrypted and does not carry keys and passwords.

### Dynamic Account Number Regeneration

Dynamic account number regeneration is another security feature allowing account numbers to be changed after is certain condition is met. There are two relevant conditions: first—change account numbers per certain number of transactions; second—change account number per certain time interval.

If one of these conditions is met, mobile phone will receive or retrieve a new account number in the following manner. Server will generate a new account number and account key, and will encrypt both using the current account key, which is stored both on the server and the mobile phone. On the phone when encrypted data is retrieved via authenticated connection, public key will decrypt current account key. Current account key will decrypted encrypted data. New account number and key will replace existing. During next transaction, new account number will arrive encrypted to server. If server will identify that new account number matches the one arrived, it will replace current account key and numbers with new ones. Otherwise, it will send command to phone to use current key and number.

Similarly, at certain time intervals or certain number of transactions which should not be the same parameters as per dynamic account numbers, server generates new public/private key pair and sends new public key encrypted by new account key to phone, where it is decrypted on the phone. New public key will replace current one. If next transaction is successful, new private key on server will replace current one. Otherwise, command is send to phone to use current public key.

MPS uses a concept of visual identification when it comes to transactions at point of sale. One of the hardware features of MPS system is CCD camera. If allowed by policy, camera will capture customer once and then each time transaction is performed, customer photo and signature will be returned to POS. Either hardware, software or personnel at POS will compare customer's photo and signature with identity of person making purchase. In case if visual identification is unavailable, signature recognition software can be used to identify customer using signature pad.

Industry standard encryption level, registration process using two-point authentications, dynamic account number regeneration where no actual account numbers are stored at customer's phone and visual identification will create unmatched security when making purchases at point of sale. Even if above methods are exposed, it will be hard for intruder to break visual identification. Therefore, such security has triple protection and is labeled in MPS as Three Levels of Security or MPS TLS.

The three security levels provided in accordance with MPS TLS may be summarized as follows:
1^{st} level: industry standard encryption.
2^{nd} level: dynamically changing account numbers and keys per account; no actual account number on the phone; phone is used as confirmation tool; GPS based determination.
3^{rd} level: visual identification of customer at POS either by personnel or software, followed by software signature recognition.
   Communication between MPS Server and POS during where image of customer and customer signature are transferred is using public key infrastructure, with information transferred being encrypted and signed using certificates. Certificates will be individually issued by MPS Server to each individual POS. Certificates will be re-issued on timely basis.

### MPS WEB—REGISTRATION

In order to use MPS, customer will need to register with MPS. There are different ways to register depending on the situation. Since the core of MPS uses mobile phones as means for payments and money transfers, registration can be achieved in a variety of ways depending upon mobile phone requirements.

Mobile phone software application stores (“app stores”) are placeholders for many mobile phones applications. Mobile applications must be submitted and approved by app store owners. The process to approve an application might take days or months. After the application is approved, customer can download that application from the app store. App stores usually guarantee authenticity and certification of the downloaded application. A limiting consideration, however, is that the application cannot be pre-compiled specifically for the registrant. For reference in this document, the registration process involving downloading application MPS MPA from an app store will be called App Store Registration Process.

In cases where customer has flexibility to install mobile application from any source desired, that allows pre-compilation of applications individually for that customer. The registration process involving downloading pre-compiled application MPS MPA will be called Custom Registration Process.

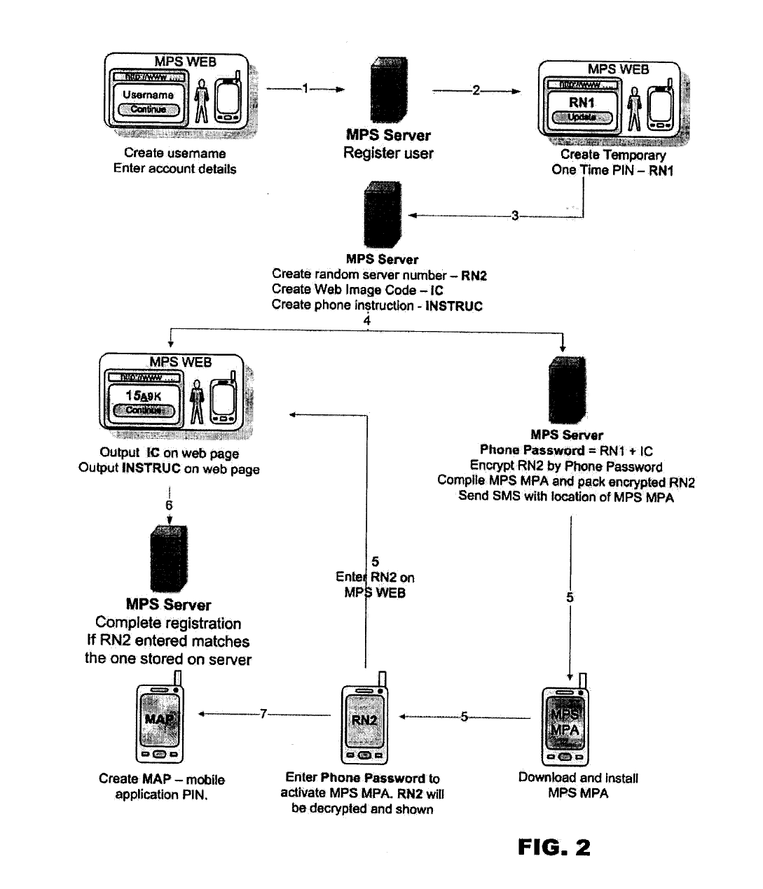

FIG. 2 depicts the concept of Custom Registration Process, using a Two-Point Dynamic Solution (TPDS) in accordance with Example #1 (previously described herein). The registration process is part of MPS Web module. Registration can occur either at a public web site or from a dedicated location (such as a bank's office if required by policy). Steps indicated by arrows in FIG. 2 are described in TABLE 1 below.

TABLE 1

| | |
|---|---|
| Step | At public or private Web site, customer will create user |
| 1 | name, password and enter his/her personal details— |
| | address, mobile phone number, etc. MPS Server will |
| | register that customer |
| Step | Customer will be prompted to create temporary |
| 2 | One Time Pin—RN1 that will be used to authenticate |
| | and activate mobile application |
| Step | Server will create Random Number—RN2 that will be |
| 3 | shown on the phone and entered by customer at Web |
| | site to authenticate him/her at Web site and to complete |
| | registration. RN2 will be stored encrypted on the phone |
| | and unencrypted on the server. Server will create IC or |
| | Image Code that is a number which along with RN1 will |
| | be part of password that will authenticate mobile |
| | application. Server will create instruction INSTRUC |
| | explaining to customer how to register mobile phone |
| | application and complete Web registration |
| Step | IC and INSTRUC will be shown at Web site. IC will be |
| 4 | shown as image rather than text to provide better security. |
| | MPS Server will create Phone password: PKEY = RN1 + |
| | WIC. It will use that password to encrypt RN2 and other |
| | security data |
| | MPS Server will compile mobile application MPS MPA |
| | individually for that customer that will include encrypted |
| | RN2 with security data |
| | MPS Server will create new random directory, place compiled |
| | application in that directory and create SMS URL link |
| | externally pointing to that directory. SMS link will be send to |
| | mobile phone provided by customer in Step 1 |
| Step | Customer will download and install application based on |
| 5 | INSTRUC. He will activate application by typing phone |
| | password that consist of RN1 he created and IC image |
| | shown on Web page. If entered successfully, RN2 and |
| | security data will be decrypted and RN2 will be shown on |
| | the phone. Customer will use RN2 number shown on the |
| | phone to enter into Web site to complete Web registration |
| Step | Server will compare RN2 entered at the Web site with the |
| 6 | one stored on the Server and if they match, Web registration |
| | will be completed. |
| Step | Customer will complete phone registration by creating |
| 7 | non-temporary Mobile Application Pin—MAP that will |
| | re-encrypt security data included in MPS MPA |
| | application and authenticate customer when invoking |
| | MPS MPA on the mobile phone |

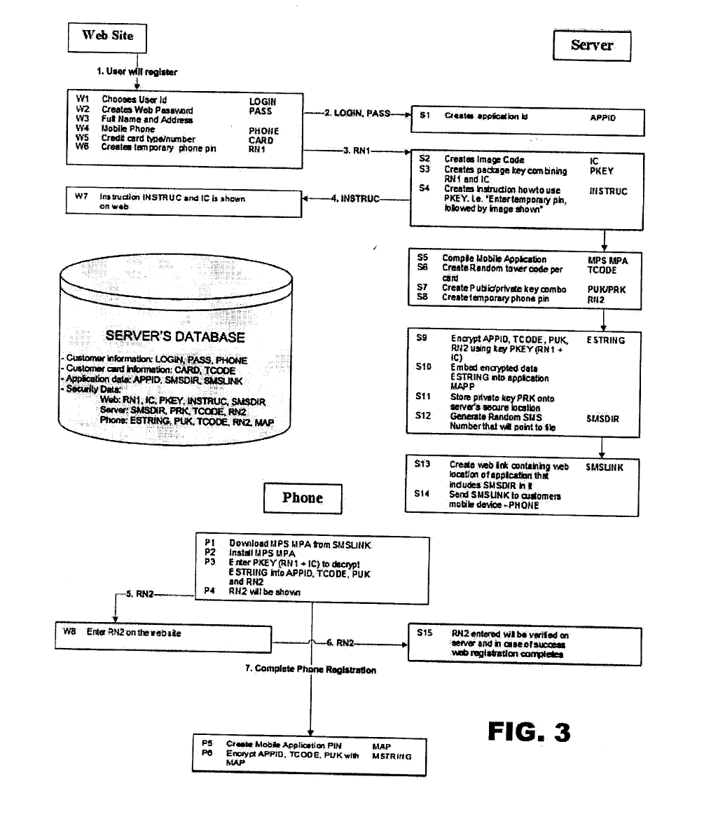

From a technical standpoint, registration process is shown in FIG. 3. MPS registration will activate user account on MPS Server and mobile phone. Once registration is finished, customer will use MPS MPA for payment transactions. FIG. 3 outlines Custom Registration Process. Process in FIG. 3 uses TPDS in accordance with Example #1. Alternatively, however, lower security can be afforded allowing fewer steps using TPDS in accordance with Example # 2 and Example #3, and partially Example #7.

Based on FIG. 3, Custom Registration is subdivided into seven main steps as outlined below:
1. Customer navigates to registration Web site that is a part of MPS Web module.
2. Customer chooses login (user) name and password, and MPS Server creates an application ID (APPID) for the chosen login name.
3. Customer enters personal information (first/last names, address, mobile phone number) and credit/debit accounts to be registered (card type, account, etc.). Customer chooses and enters 4 digits as a temporary pin—RN1 (random number 1)—to register personal information and credit/debit accounts above. Steps 1-3 corresponds to steps W1-W7 and S1 in FIG. 3.
4. MPS Server will receive temporary registration pin RN1 entered by customer and will perform the following actions:
   a. Create random image code—IC, which will be shown to customer on the Web site as an image
   b. Combine RN1 and IC into key PKEY, which will be entered by customer on his mobile phone to authenticate mobile application MPS MPA.
   c. Create instruction—INSTRUC that will be shown on Web site that explains how to activate mobile application on mobile phone. IC code will be also shown on the same page. Here is the following example of INSTRUC:
      Wait for SMS to be received from slmps.com. SMS contains link to mobile application. Choose that link to download and install mobile application. Open mobile application and activate it by entering temporary PIN you had chosen in previous step, followed by image shown on this Web page.
   d. Compile mobile application—MPS MPA, individually per customer by creating the following data packed into application and server
      TCODE—random tower code per card(s) that can change per transaction or per period defined.
      PUK/PRK—combination of asymmetric public/private key that will be used to encrypt information on mobile phone and decrypt on server. PUK will be part of MPS MPA package (encrypted in ESTRING), PRK is stored on server
      RN2—random number that will be stored on server and packed into MPS MPA package as part of encrypted ESTRING. RN2 will be shown after successful activation of MPS MPA and entered on Web site to complete registration. Registration will succeed when number entered on Web site will match stored on server.
   e. Combine APPID, TCODE, PUK and RN2 into string and encrypt that string into ESTRING using PKEY above as key via symmetric encryption algorithm. ESTRING will be embedded into MPS MPA.
   f. Create random number—SMSDIR that will be appended to SMSLINK. SMSLINK is URL location where compiled MPS MPA will be physically stored. SMSLINK will be sent to customer's mobile phone, from which customer download MPS MPA.

The procedures of this step 4 correspond to steps S2-S14 in FIG. 3.
5. Customer based on INSTRUC above will
   a. Receive SMS with SMSLINK
   b. Download MPS MPA application from SMSLINK and install it
   c. Open MPS MPA and will enter PKEY which is a RN1 he created followed by image shown on Web page. Since ESTRING was encrypted by PKEY, it will also be decrypted by PKEY.
   d. If PKEY was entered successfully, RN2 will be shown

The procedures of this step 5 correspond to steps P1-P4 in FIG. 3
6. Customer will enter RN2 shown on the phone into Web site to complete Web registration. MPS Server will compare number entered to the one stored on the server. If they match, Web registration completes.

This step 6 corresponds to steps W8, S15 in FIG. 3
7. Customer will proceed to the next screen in MPS MPA on the mobile phone to choose Mobile Application Pin—MAP. MAP will re-encrypt APPID, TCODE and PUK into MSTRING. MPS MPA registration completes.

The procedures of this step 7 correspond to steps P5-P6 in FIG. 3

No actual card accounts are stored on the phone. Only IDs associated with that account, plus brief descriptions (e.g., card type, followed by last 4 digits of card account) will be stored on the phone.

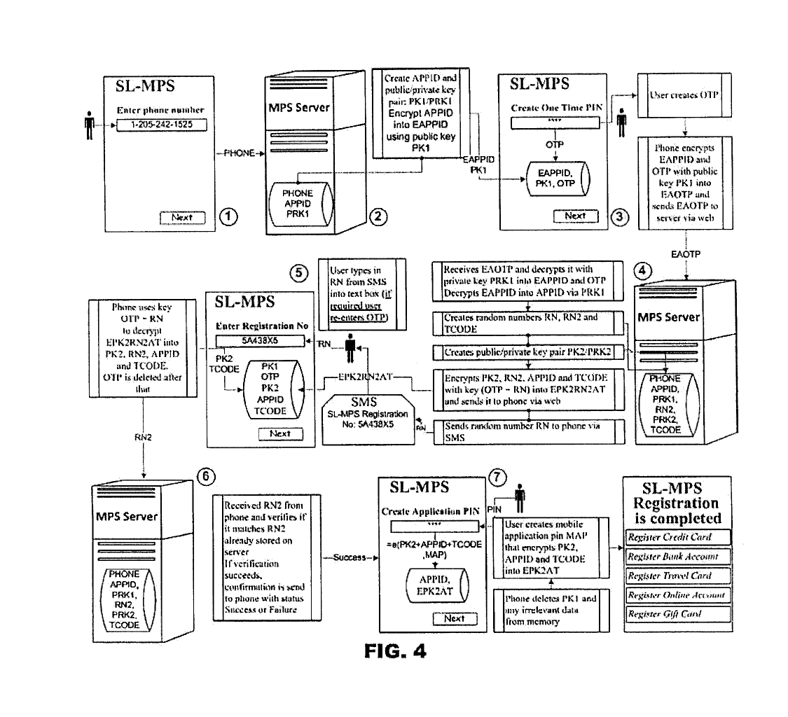

App Store Registration Process is shown in FIG. 4 from schematic and technical points of view. In accordance with FIG. 4, App Store Registration is subdivided into 7 main steps outlined below. TPDS in accordance with Example #5 is used in FIG. 4. Different variations depending on security are allowed for authentication of registration process.
1. Customer downloads application from App Store, and enters phone number (PHONE) into application which will be submitted into MPS Server. In cases when API calls are available to retrieve phone number, PHONE entered will be compared to the one retrieved from API and if no similarity found, registration will halt. Customer will submit information to MPS Server via a secure http connection. and MPS MPA will wait for response from MPS Server.
2. MPS Server will receive phone number from customer's mobile phone; it will check whether such number is already registered. If number is not registered, server will generate application ID APPID and create public/private key pair PK1/PRK1. APPID will be encrypted into EAPPID using public key PK1. EAPPID and PK1 will be sent back to mobile application via secure http connection. If required, APPID can be transferred unencrypted to establish correct identity of application; however secure http connection should achieve that goal.
3. Once EAPPID and PK1 are received by MPS MPA, TPDS Example #5 will be used in desired variation. MPS MPA will encrypt OTP and EAPPID with public key PK1 into EAOTP. EAOTP is submitted over secure http connection and MPS MPA will wait for response from MPS Server. If required, APPID can be transferred unencrypted to establish correct identity of application; however secure http connection should achieve that goal.
4. MPS Server will receive EAOTP via secure http connection and
   a. It will use corresponding private key PRK1 will decrypt EAOTP into EAPPID and PRK1. If APPID was transferred by requirement unencrypted, it should be used as an additional measure to identify PRK1. EAPPID will be decrypted into APPID via PRK1. If APPID was transferred by requirement unencrypted, it will be compared to the decrypted one and they should match.
   b. It will create random numbers RN, RN2 and TCODE
   c. It will create public/private key pair PK2/PRK2
   d. It will encrypt PK2, RN2, APPID and TCODE into EPK2RN2AT using key that is a string combined from OTP and RN. EPK2RN2AT will be sent to mobile application via secure http connection
   e. RN will be send to mobile phone via SMS message (using short messaging service protocol)
5. Customer will receive SMS with RN number in it and EPK2RN2AT via http connection. Customer will be prompted to enter RN from SMS into mobile application. Depending on TPDS Example #5, user will either enter OTP followed by RN or just RN. Key consisting of OTP+RN will decrypt EPK2RN2AT into PK2, RN2, APPID and TCODE with RN2 automatically sent to MPS Server via secure http connection. Mobile application MPS MPA will wait for response from MPS Server
6. MPS Server will verify RN2 received from mobile phone with the one stored on server and if they match, MPS will send notification status of success via secure http connection. Note that RN2 can optionally be entered manually by customer to be submitted to MPS Server. When RN2 is decrypted on phone it can be shown as an image and then entered by customer for submission to MPS Server. If chosen, it will create even more tight security but increase number of steps required to complete registration.
7. In case mobile application will receive successful confirmation of registration from MPS Server, customer will be prompted to create Mobile Application Pin—MAP that will be used to authenticate application with each consecutive invocation. Once customer will enter and confirm PIN number, PK1 will be deleted and mobile application will encrypt PK2, APPID and TCODE into EPK2AT using MAP as key.

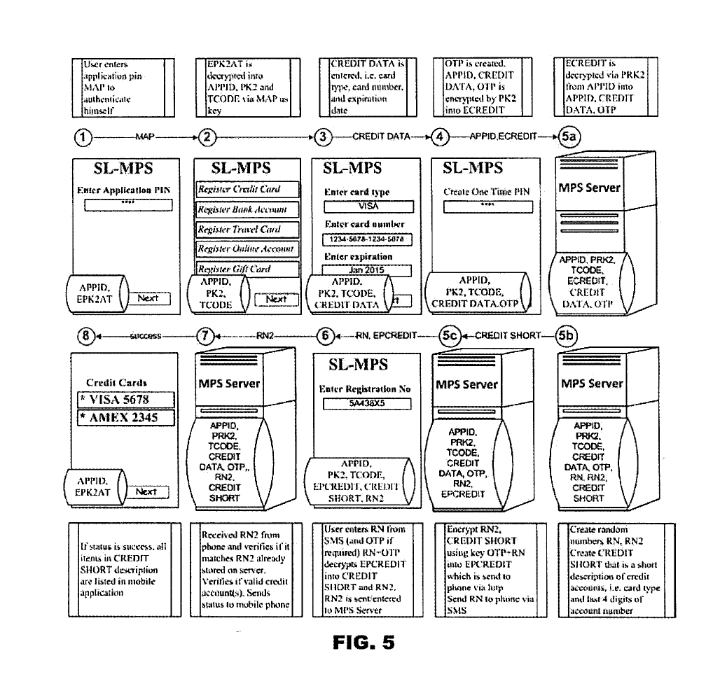

App Store Registration Process for registering credit accounts is shown in FIG. 5, using TPDS Example #5. Different variations depending on security are allowed for authentication of registration process. App Store Registration Process per FIG. 5 is subdivided into eight 8 logical steps, and uses the same methodology of RN, RN2, OTP concept illustrated in FIG. 4:
1. User enters application pin MAP to authenticate himself or herself.
2. EPK2AT stored on phone is decrypted into APPID, PK2 and TCODE via pin

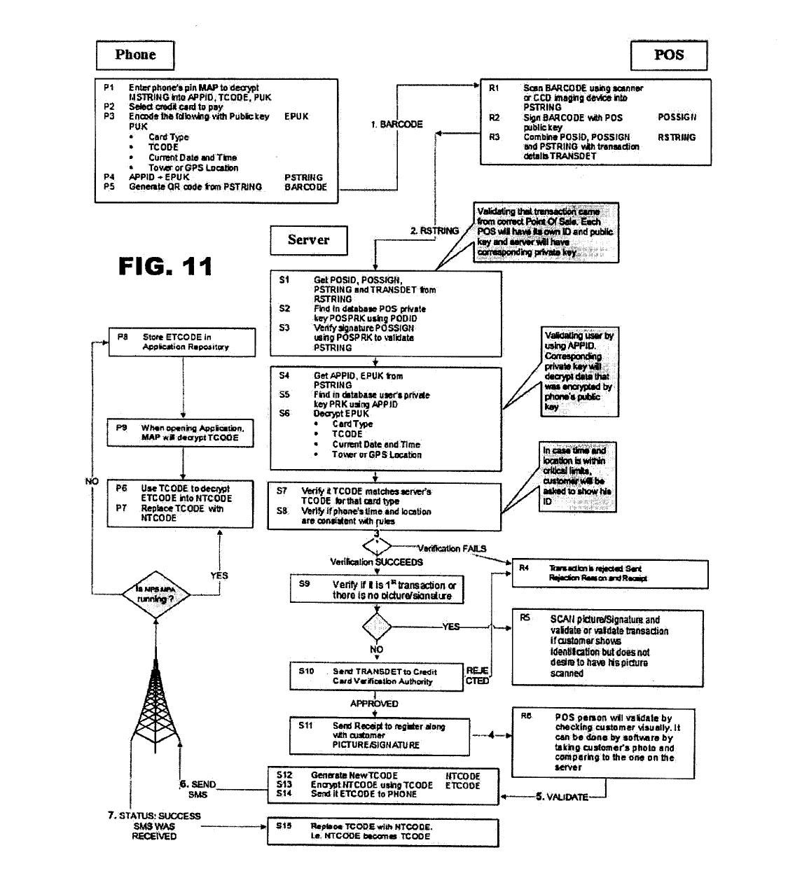

MAP above as key. Options to register new accounts followed by list of different accounts to register will be provided.
3. CREDIT DATA is entered, i.e. card type, card number, and expiration date.
4. Similarly to registration approach illustrated in FIG. 4, OTP is created using TPDS Example #5. APPID, CREDIT DATA, OTP are encrypted by PK2 into ECREDIT.
5. MPS Server will receive APPID and ECREDIT via secure http connection. Then:
   a. ECREDIT is decrypted via PRK2 using mobile's phone APPID into APPID, CREDIT DATA and OTP. APPID decrypted must be equal to the one received;
   b. MPS Server will create random numbers RN, RN2; it will create CREDIT SHORT that is a short description of credit accounts, i.e. card type and last 4 digits of account number; and
   c. MPS Server will encrypt RN2, CREDIT SHORT using key OTP+RN into EPCREDIT which is send to phone via http. Then, it will send RN to phone via SMS.
6. User will receive SMS with RN and enter RN into application (and/or OTP if required based on TPDS #5. RN+OTP will decrypt EPCREDIT received from MPS Server via secure http connection into CREDIT SHORT and RN2. RN2 will be sent or entered (if manual RN2 entry is desired for better security) to MPS Server via secure http connection.
7. MPS Server will receive RN2 from phone and will verify if it matches RN2 already stored on server. MPS Server will verify if valid credit account(s) submitted for registration are valid. It will then sends status to mobile phone whether registration of credit accounts succeeded.
8. If Mobile Application MPS MPA will receive status of success, all items in CREDIT SHORT description will be registered into MPS MPA mobile application and listed within application.
   Public key PK2 in FIGS. 4 and 5 corresponds to PUK in FIGS. 3 and 11
   Once either of the registration processes is completed, customer can use MPS MPA on mobile phone to pay at POS, on the internet and/or over the phone and to make money transfers.

### REGISTRATION AT POINT OF SALE

Another way to register customer with MPS is at Point of Sale with either MPS PID or MPS POS modules installed.

At Point of Sale (POS) with either MPS PID or MPS POS modules installed, customer will provide his credit account details to device allowing retrieving credit account details.

In case when credit accounts are represented as plastic cards with magnetic stripe, device to retrieve credit account details will be magnetic card reader.

In case when credit accounts are represented as plastic smart cards with embedded chips allowing transferring information using contact-less methods such as tapping, device to retrieve credit account details will be contact-less smart card reader.

In case when credit accounts are represented in non-plastic forms such as barcodes, images, sound waves or other representations, device to retrieve such credit account details will be provided at POS.

Magnetic card reader or contact-less smart card reader or input module allowing reading credit accounts in non-plastic form will be embedded into MPS PID or used as standalone device in MPS POS.

Mobile phone information will be taken from customer's mobile phone. That will include mobile phone number provided by customer to personnel at POS and mobile phones' model type and number that will be collected by personnel at POS. Mobile phones' model type and number can be determined by retrieving IMEI or ESN number from that mobile phone.

Customer's mobile phone information will be sent to MPS Server. Customer's credit account data retrieved from device allowing retrieving credit account details will be sent to that credit account issuer. Example of credit account issuer can be banking institution issuing credit and debit cards.

Credit account issuer will retrieve details about that customer as well as details about credit account for that customer. Customer's details will include customer personal information such as name and address as well as customer's credit history. Retrieved customer's details and customer's credit account details will be distributed to MPS Server. MPS Server will store customer and credit account details along with mobile information received from MPS PID or MPS POS into customer account registration details.

MPS Server will generate random confirmation code and send it via SMS into customer's mobile phone. Customer will provide that code to personnel at POS. Personnel at POS will ask customer to provide visual identification documents that contain customer's name and photo. Snapshot of customer photo and signature will be taken. If visual identification is passed, personnel at POS will enter confirmation code provided by customer. Confirmation code with picture and signature will be submitted into MPS Server using MPS PID or MPS POS.

If confirmation code provided by personnel at POS will match to confirmation code sent to customer, MPS Server will verify whether that customer is registered with MPS.

In case customer is registered with MPS, credit account details encrypted by confirmation code are sent to MPS MPA or MPS MPA will download credit account details. Confirmation code will either be entered automatically by MPS MPA or re-entered by customer to decrypt credit account details in MPS MPA. If more advanced level of security is required, MPS Server will generate new confirmation code, encrypt credit account details with it and deliver encrypted credit account details and separately new confirmation code to MPS MPA. Then, new confirmation code will be entered by customer and decrypt credit account details. Credit account details will include TCODE described in Application Store Registration and Custom Registration Processes

In case customer is not registered with MPS, MPS Server will register customer from stored customer account registration details and picture/signature taken will be stored. MPS Server will send MPS MPA installation instructions to POS where either personnel at POS or customer can install MPS MPA on mobile phone.

Depending on mobile's phone module and type, country where customer resides, mobile operator and other parameters, MPS Server has two options for MPS MPA: MPS MPA can be individually compiled and stored on MPS Server or MPS MPA can only be stored in third-party mobile application store.

In case MPS MPA will be located at mobile application store, MPS Server will create and store secure data for MPS MPA. In case MPS MPA can be individually compiled, secure data will be embedded into MPS MPA.

Similarly to Application Store Registration and Custom Registration Processes, secure data will contain APPID, TCODE and public key PK with private key PRK stored on server.

Secure data will be encrypted on MPS Server by confirmation key mentioned above. In case more advanced security will be required, new confirmation key will be created that will encrypt secure data. In this case, new confirmation key will be send to the phone at the same time MPS MPA installation instructions are sent to POS.

When application is installed, it will be activated by re-entering confirmation code described above or entering new confirmation code in case more advanced security is desired. In either case, after activation, Mobile Application PIN—MAP will be created that will encrypt APPID, TCODE and PK.

The diagram below illustrates this process:

### MPS PID, MPS POS—PAYMENT AT POS

MPS is a modular payment system. For payments at Point of Sale—POS, there are two 2 options available: MPS PID and MPS POS.

MPS PID is a communication hardware used as an interface between any third-party POS and MPS Server. MPS PID is a modular device that can accept different payment input modules using standard ports such as USB or serial ports. MPS PID will read input from those payment modules and communicate received information to MPS Server and Point Of Sale. Communication between MPS PID and POS uses a standard POS communication protocol that allows MPS PID to be independent of third-party POS hardware and software. MPS PID operating system allows receiving software updates using push technology where MPS Server communicates digital updates to each individual MPS PID.

MPS POS is standalone Point-Of-Sale software suite used as a communication interface between MPS Server and various POS hardware. MPS POS is designed with existing POS standards such that it can be installed on any available POS hardware. It may be designed to accept existing and new hardware and software methods of payments via software modular design such that new plug-ins for new input/output transactional technologies can be added. Due to modular design, existing POS software companies can accommodate MPS POS functionality in their POS software systems. Modular design will be based on default and custom packages. In cases where custom package classes will exist, they will be used; otherwise, default package will be used. When different custom packages exist, the one to be used will be defined in MPS POS preferences. MPS POS is also designed to receive software updates using push technology where MPS Server communicates digital updates to each individual MPS POS.

In alternative embodiments, MPS PID and MPS POS can be adapted to accommodate current technologies such as magnetic swipe readers as well as new and emerging technologies such as RFID/NFC readers and NSDT readers.

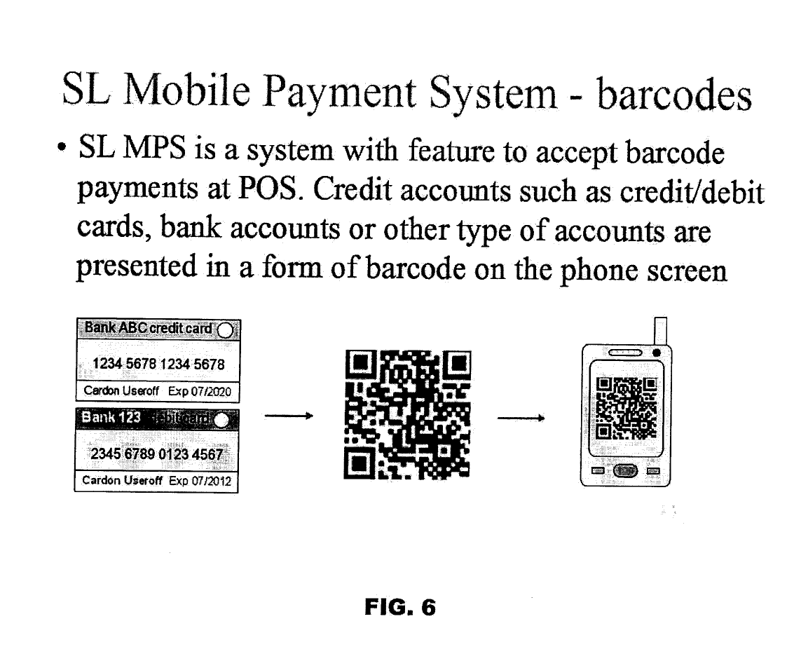

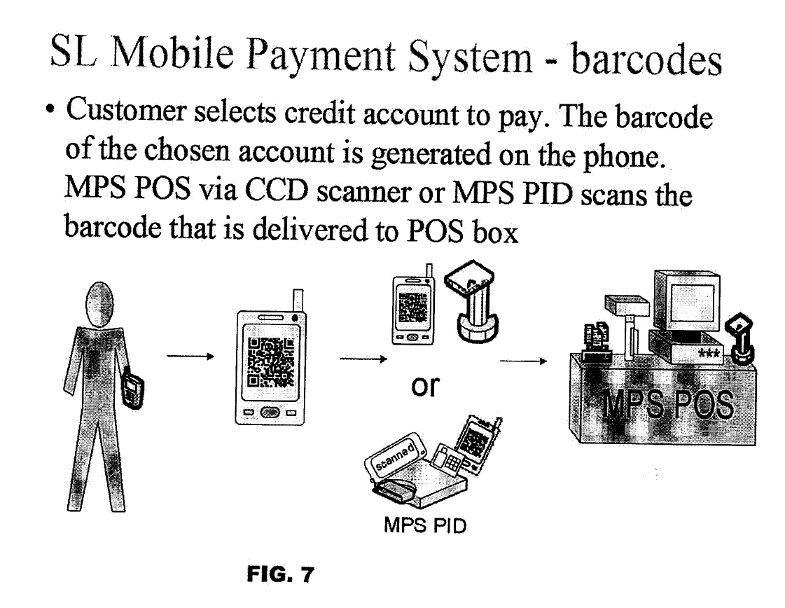

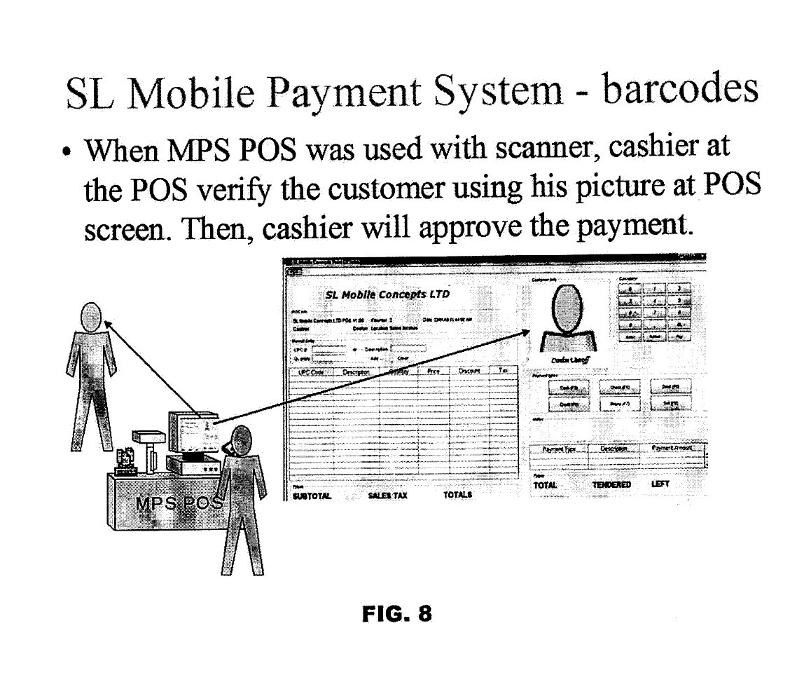

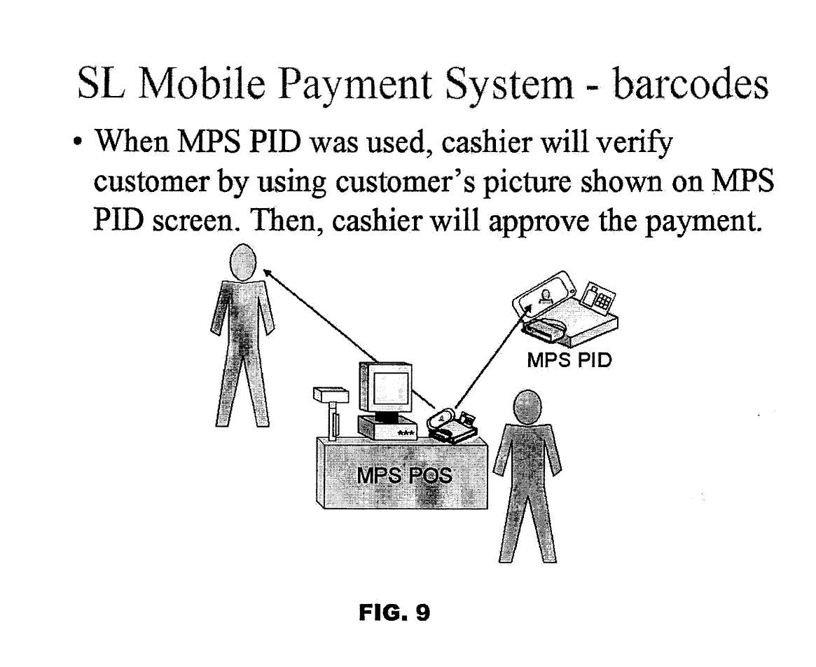

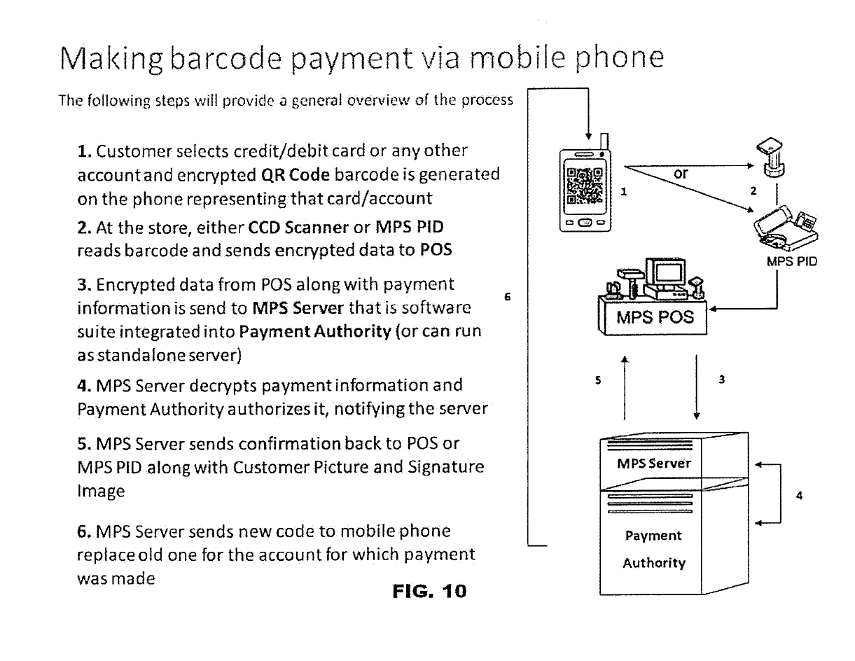

FIGS. 6-10 illustrate the concept behind barcode payments at POS using MPS. FIG. 11 outlines technical payment process at POS using either MPS POS or MPS PID modules. It should be noted that public key PK2 shown in FIGS. 4 and 5 corresponds to PUK in FIG. 11. A “dynamic account numbers regeneration” security feature is used during transaction process

POS Payment is subdivided in seven main steps shown in FIG. 11, and summarized as follows:
1. Following the conventions from FIG. 3, customer will open MPS MPA and will enter application pin—MAP to view list of registered accounts. Once entered correctly, MPS MPA will:
   a. decrypt APPID, TCODE and PUK using MAP key via symmetric algorithm;
   b. Customer will select which card to pay from the list of accounts;
   c. Card ID, card type, TCODE, current date and time, GPS location will be encrypted by PUK into EPUK via asymmetric algorithm;
   d. APPID will be combined with EPUK into PSTRING; and
   e. QR Barcode—BARCODE—will be generated from PSTRING.

The procedures of this step 1 correspond to steps P1-P5 in FIG. 11.
2. Customer will bring phone for BARCODE to be scanned either by CCD scanner or MPS PID:
   a. MPS POS or MPS PID will sign BARCODE with POS public key into POSSIGN string.
   b. POSID that is unique POS identification number, POSSIGN string, PSTRING extracted from BARCODE via scanner and TRANSDET that are transaction details—description of merchandise, amounts paid, etc. entered at POS will be combined into RSTRING that will be send to MPS Server.

The procedures of this step 2 correspond to steps R1-R3 in FIG. 11.
3. MPS Server will receive RSTRING from MPS POS or MPS PID and:
   a. Retrieve POSID, POSSIGN, PSTRING and TRANSDET from RSTRING;
   b. Based on POSID, find POSPRK that is POS private key associated with POS public key;
   c. Using POSPRK, verify signature of POSSIGN that will validate PSTRING;
   d. Get APPID, EPUK from PSTRING
   e. Find Customer's private key PRK based on APPID;
   f. Decrypt EPUK using PRK key into Card ID, Card type, TCODE, date and time, GPS location;
   g. Verify if TCODE matches TCODE stored on server per that card type; and
   h. Verify if time and location are consistent with rules defined for it.
      In cases where sub-steps a.-h. are not successfully applied and verified, MPS Server will send notification to MPS POS or MPS PID with rejection reason. Otherwise:
   i. If there are no transactions exists per that card in MPS Server or no picture or signature of customer exists on server, notification is send to MPS POS or MPS PID. Based on policies, cashier can either request customer to show valid identification and to take a picture/signature of him using CCD Scanner or MPS PID device or just request to provide valid identification. CCD Scanner or MPS PID use CCD technology that works as digital camera allowing taking snapshots—step R5. Whether taking photos or not, cashier will validate customer if he provides valid identification. In this case cashier submits via MPS POS or MPS PID that transaction is valid, otherwise transaction is invalid.
   j. If it is not the case specified above or it is the case and cashier validates transaction, transaction details TRANSDET will be send to Payment Authority (usually bank) to check for funds per that card, if card has not expired, if card is valid, etc.—step S10. MPS BIL module is used for communication between Payment Authority and MPS Server.
   k. If Payment Authority rejects card verification, receipt will be send to MPS POS or MPS PID, otherwise transaction is approved.

The procedures of this step 3 correspond to steps S1-S10, R4-R5 in FIG. 11.
4. When transaction is approved, receipt, customer photo and signature is encrypted and signed based on POSID. Information is send to MPS POS or MPS PID, where it is verified and decrypted based on POSID.

This step 4 corresponds to step S11 in FIG. 11.
5. Cashier will visually validate customer based on his photo and signature returned from MPS Server if such policy is enabled and submit that request to MPS Server. Rules can be created at POS or MPS Server not to do visual verification if purchase amount is less then certain amount limit specified by policy. Optionally and in case if visual verification is required, software at MPS POS or MPS PID can validate customer instead of cashier by comparing signature provided by customer with signature returned from server. Software can also automatically take picture of customer using face identification techniques and compare it to photo returned from server. Once MPS Server will receive validation, it will
   a. Generate new TCODE, called NTCODE per card
   b. Encrypt NTCODE with TCODE as key into ETCODE via symmetric encryption
   c. Send ETCODE to customer mobile phone MPS MPA using SMS push notification

The procedures of this step 5 correspond to steps R6, S12-S14 in FIG. 11.
6. In case MPS MPA is not running, ETCODE will be stored in phone's push registry. When application will be open and customer will enter application pin—MAP, as it was seen in step 1a or step P1 in FIG. 11, TCODE will be available. In case when application is running, TCODE is already available

This step 6 corresponds to steps P8-P9 in FIG. 11.
7. TCODE will decrypt ETCODE into NTCODE (since TCODE was used as key on server to perform the same operation). Once decrypted, TCODE is replaced with NTCODE, i.e. TCODE=NTCODE. In meantime, when SMS received into mobile phone, mobile tower will be notified and in turn it will notify MPS Server that listens to replies from tower (all of this is a part of SMS protocols). Once MPS Server will receive status of SUCCESS, it will perform the same task as it was done on mobile phone MPS MPA. It will replace TCODE with NTCODE, thus completing transaction cycle.

The procedures of this step 7 correspond to steps P6-P7, S15 in FIG. 11.

### MOBILE PHONES WITH PARTIAL PUSH OR NO PUSH TECHNOLOGY

In rare cases where mobile phones do not have push technology functionality or SMS cannot be delivered in binary format to MPS MPA mobile application, steps S14, P8, P9 and S15 in FIG. 11 are carried out differently. Step S14 will only be required when partial push technology is enabled, notifying that transaction was processed.

If no push technology exists, after barcode was generated, MPS MPA will connect via http connection to MPS Server and will try to poll MPS Server for existence of ETCODE. Polling will be done few times with specified time intervals. It will download ETCODE and will use the same workflow in FIG. 11 starting from step P6 until S15. Step S15 will be triggered differently then in FIG. 11. MPS MPA will notify MPS Server via http connection that steps P6 and P7 are finished successfully and step S15 will be triggered

If partial push technology exists, where SMS will arrive just to notify application that transaction occurred, at step S14 instead of sending ETCODE, regular notification is sent about transaction processing. Customer should enter MPS MPA and it will attempt to download ETCODE. Then it will use the same workflow in FIG. 11 starting from step P6 until S15. Step S15 will be triggered differently then in FIG. 11. MPS MPA will notify MPS Server via http connection that steps P6 and P7 are finished successfully and step S15 will be triggered

### OTHER PAYMENT METHODS

MPS employs existing payment methods such as Magnetic Swipe Reader as well as it can accommodate new technologies such as NFC, RFID, NSDT, biometric reading and others.

### Magnetic Swipe Reader

For customer who use standard plastic credit cards or credit cards with PIN code, MPS work as any other transactional system in the market but with benefits of visual security.

### RFID Reader

For RFID transaction, MPS will use FIG. 11 with only difference in steps P5 and R1 where barcode generation and scanning is replaced with RFID tag generation—P5 and RFID reader tag scanning—R1. If there is a case that pin—MAP is not required to activate application step P1 is not required leaving APPID, TCODE and PUK unencrypted by MAP.

### NFC Input/Output Device

For NFC two-way transaction, MPS will use FIG. 11 with difference in steps P5, R1, S14 and S15. Barcode generation and scanning is replaced with NFC tag generation—P5 and NFC Input Output Device tag scanning—R1. If there is a case that pin—MAP is not required to activate application step P1 is not required leaving APPID, TCODE and PUK unencrypted by MAP. Step S14 and S15 are modified only in terms of delivery methods. In step S14 ETCODE is delivered to phone via NFC Input/Output Device. At step S15, notification is sent back to MPS Server via NFC Input/Output Device.

### NSDT Input/Output Device

For NSDT two-way transaction, MPS will use FIG. 11 with difference in steps P5, R1, S14 and S15. Barcode generation and scanning is replaced with NSDT sound generation in steps P5 and R1. Step S14 and S15 are modified only in terms of delivery methods. In step S14 ETCODE is delivered to phone via sound as well at step S15, notification is sent back to MPS Server via sound.

### Biometric Reader

For biometric transaction, MPS can be used along with other technologies above to identify customer's identity. Other systems can use transactions using its normal techniques, while biometric reader will separately verify if customer is associated with the same user used in other systems by extending MPS PID or MPS POS functionality

If proprietary methods of delivery are required for RFID, NFC and NSDT technology, those technologies can be implemented in MPS accordingly to their specifications rather than the method used in FIG. 11.

### MPS SECURITY FEATURES

If SMS push is used for TCODE updates, TCODE per account can optionally be updated based on time interval rather than per each transaction or number of transactions—depending on vendor's requirements. For example, replace TCODE once a day for all transactions occurred during the day and replace TCODE once a month for accounts that has no activity.

MPS MPA will be deactivated if inactive for specified period of time. During deactivation, all data stored is encrypted by MAP. To activate it, MAP should be re-entered.

Mobile phone MPS MPA does not store actual account numbers but only descriptions which gives intruder no ability to use it

MPS Server can send passwords along with TCODE that will be required for customers to enter to complete transaction at POS. Since MPS MPA is software, it can be easily implemented.

POSPID—ID of each POS, along with symmetric and public/private key will change per random intervals to increase security measures.

Based on policies and if required, MPS MPA on mobile phone can request user to change its application pin MAP.

Synchronization between MPS Server and MPS MPA will be used in cases such that when SMS is not delivered to MPS MPA or related issue

All customer data stored on the phone can be wiped out remotely by specifying option on MPS Web site that is part of MPS Web module. Customer data is stored on the server and can be re-downloaded to the phone, once conflict is resolved

QR barcode representing accounts on the phone is a matrix barcode that can contain up-to 4296 alphanumeric characters. It uses Reed-Solomon error correction that can restore maximum of 30% of code words. It is free of any license. However, any other type of barcodes can be used.

If visual identification is enabled, MPS TLS—three levels of security concept is enabled providing highest security levels at POS transactions.

### ADVANTAGES AND BENEFITS OF BARCODE PAYMENTS

As can be seen, barcode payment is a software payment solution from customer point of view. Due to that fact, it is a huge benefit for a manufacturer of mobile phones, credit issuing authorities, environmental agencies, marketers, online payment authorities, banks, customers and retailers. Software solution allows natural evolution of new enhancements.

For phone manufacturers, it does not require any hardware modification in mobile phones, thus saving money on production infrastructure.

For credit issuing authorities and mobile service providers, it does not require production of plastic cards, chips with embedded RFID/NFC functionality or similar means of payments where raw materials are involved.

For environmental agencies, it allows saving natural resources used in producing plastic cards and phone chips as well as eliminating pollution used in process of producing cards and chips.

For marketing, QR barcodes present humongous opportunity. Barcodes allow to have embedded digital coupons representing discounts, tickets, promotions in them. Few methods of receiving digital coupons are available. One of them is delivery using messaging. Another method is scanning digital coupons using phone's camera. Scanning can be done from any available place including computer screens, posters, newspapers, bus stands, etc.

For online payment authorities where customer' credit accounts can only allow to make online payments, barcodes representing those accounts on mobile phones for the first time allows to make purchases at physical location such as malls, restaurants, etc.

For banks, it allows creation of its own virtual credit or debit card using dynamically changing account numbers, thus saving on fees paid for using brand names. When credit cards are lost or stolen, banks save money on card replacement. In comparison, redelivery of software based credit accounts can happen almost immediately. Security measures such as when actual account numbers are not stored on the phone and virtual numbers dynamically change allows to minimize fraud and theft. Visual identification of customers decreases chances of fraud and theft to even greater extent. Since software is used, in case of threats, it can be quickly disabled and updated over the air.

For customers, there is a comfort to keep all credit accounts and coupons in one place protected by pin they know. In case mobile phone is stolen, data can be automatically erased from remote location. When matter is resolved, all credit accounts can be redelivered instantaneously rather then waiting to receive new replacements by mail.

On retailer's side, in case retailers do not want to change existing infrastructure, MPS PID can be used. MPS PID is a device running Linux OS, thus allowing updating its software using worldwide known OS. MPS PID is designed to be extendible allowing new physical and software elements to be added into it, such as NFC, RFID, NSDT readers, etc.

Software solution allows natural evolution of new enhancements. Such enhancements can represent barcode accounts as transportation cards, student cards, entry cards, venue tickets, airline tickets, custom franchise accounts, etc. Location based shopping can be added along with barcode payments allowing faster service and customer comfort. For example, customer can pre-pay item over the location based phone shopping. Merchant will prepare pre-paid item before customer arrive. Customer will present barcode that will be used check out an item.

Since mobile phone is mini computer, software can vary depending upon creativity of inventors who will desire to extend system with new features. This creates opportunities for new jobs market.

Visual identification at POS can move forward visualization industry where customers can be identified via visualization software that samples customer face patterns. This allows creation of Research and Development Centers.

### PAYMENTS OVER INTERNET AND OVER THE PHONE

MPS is designed to make purchases over the internet and over the phone using the same concept of authentication by using Two-Point Dynamic Solutions (TPDS).

Besides using TPDS, most of mobile phones have GPS coordinates based on GPS chips or tower location coordinates. Many customers use common place to shop on internet and over the phone such as home, work, etc. Therefore, MPS has an ability to identify whether shopping was done at unusual locations. Such transactions can be tracked and customer support can verify if customer is real.

MPS employs different methods using TPDS concept. Each method can implemented based on policy as desired. Those methods are described further herein.

### Authentication Methods for Web-Based and Over-the-Phone Voice Transactions via Mobile Phones

There is a category of customers who make purchases over the internet. There is also a category of customers who make purchases over the phone by calling merchants.

In the case of internet transactions, to make a purchase the customer usually authenticates himself by entering a user ID and password on the merchant's Web site. User ID and password are used to protect the customer's personal data such as credit cards, bank accounts as well as authenticate the customer during purchase. Since the customer is the only one who knows his or her user ID and password, it can be concluded hat the person who makes a purchase is that customer.

In the case of voice phone transactions, when a customer is calling to a merchant to make a purchase, he (or she) usually authenticates himself (or herself) by stating his personal data over the phone. Personal data can be, for example, an address, part of an identification number proving the customer is the resident, credit information such as credit card number, credit card expiration date, etc. Since the customer is the only one who knows his personal and credit data, it can be claimed that person who makes a purchase is that customer.

However, in case of both internet transaction and over-the-phone voice transactions, there are numerous cases of intrusions when customer as well as merchant data is obtained by unauthorized parties. In both internet and over-the-phone transactions, intruder uses theft, social engineering techniques, custom hardware, and software to gain access to individual accounts or to the overall system.

In order to minimize attempts of unauthorized intrusions, mobile phones can be used as an additional security measure to authenticate internet or over-the-phone transactions. In this case, standard authentication will be followed by additional authentication using mobile phones. Different general techniques were was described in TPDS methods

Specific details on how to make Web-based and over-the-phone transactions using concepts of TPDS is provided. Each specific method is be labeled with word METHOD, followed by space, capital letter M, integer number, colon, space and title. For example, METHOD M1: Simple SMS Authentication.

Certain assumptions that are applicable to all methods are as follows:
1. Customer and merchant must be registered in the same domain or with the same entity;
2. Communication on mobile phones can use few methods with messaging as one of them and Web connectivity as another; and
3. Merchant can either have either full or partial access to customer's credit information with latter considered to be more secure.

Assumption 1: Both customer and merchant must be registered with entity that has capability to provide “two points authentication”. That capability includes verifying input from registered customer and merchant and providing required means of communication between customer and merchant to complete transaction. For simplicity, such entity will be called Mobile Payment System Server or MPS Server

Assumption 2: Short Messaging Service or SMS is one of the protocols that allow mobile phones to send and receive information using SMS messages. HTTP is common protocol that allows mobile phones and personal computers to connect to HTTP-based Web sites to send and receive information. Either one or both protocols will be used in outlined methods.

Assumption 3: MPS Server is a keeper of customer's credit information. Merchants will either have full or partial access to customer's credit information. When merchant has only partial access to customer's credit data, it is more secure since there is no possibility of customer credit data leaking out from many different merchants. It also provides safety and comfort to customer, especially when communicating credit information to merchant over the phone. If customer is unsure whether it is the true merchant that he is communicating with, provision of only partial credit information will only allow merchants registered with MPS Server to process transactions. Thus, partial credit information will not be enough for unauthorized entities to make transactions elsewhere. For simplicity, customer's partial credit information will be referred to as shortened credit data or credit account in shortened form. As an example, shortened credit data can include credit card type and last 4 digits of credit card number (e.g., Visa 5234).

Further on in this patent specification, authentication with user and password on the Web site will be referred to as Web authentication. Authentication by providing personal data over the phone will be referred to as voice authentication. Regular authentication will be referred to as when either of two methods above will be used. Authentication on mobile phone will be referred to as mobile authentication.

### METHOD M1

### Simple SMS Mobile Authentication

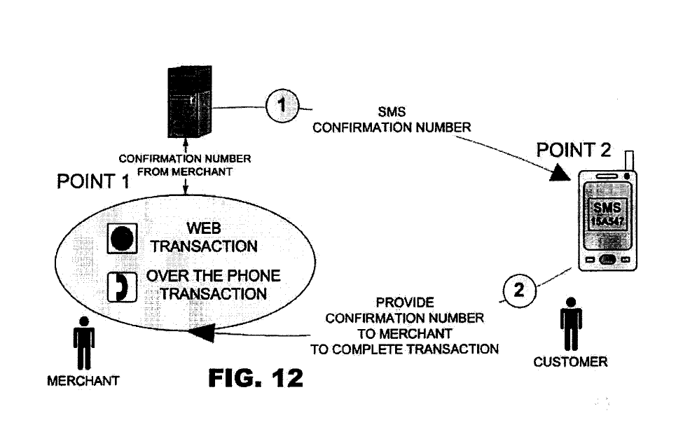

M1 Summary: After regular authentication in order to proceed with transaction, SMS with confirmation number is sent to mobile phone. Confirmation number from SMS will be provided by customer to merchant where merchant will use that number to complete transaction. Confirmation number in SMS provides extra security since it is used outside of process of regular authentication. Intruder must have access to both customer's mobile phone and Web or voice connection to gain access to private data. Concept is shown in FIG. 12 and it uses technique of TPDS #7.

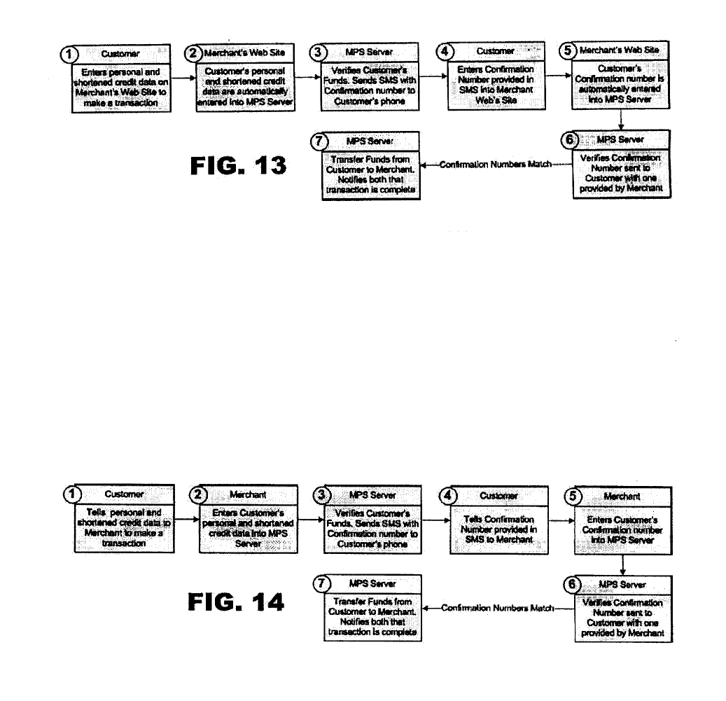

FIG. 13 depicts Simple SMS mobile authentication preceded by Web authentication and FIG. 14 depicts Simple SMS mobile authentication preceded by voice authentication. The methods illustrated in both of these Figures use the same concept to authenticate customer using mobile phones after regular authentication is performed.

In FIG. 13 at step 1, customer will enter his credentials on merchant's Web site to get authenticated. Regular authentication will be performed on MPS Server via merchant's Web site that will use standardized secure internet session such as SSL over HTTP that will both identify customer and merchant. As per Assumption 1, both customer and merchant are registered with MPS Server.

Shortened credit data such as credit card type and last 4 digits of credit card number will be chosen by customer from list of credit accounts registered at MPS Server. Optionally, customer can enter CVV/CVC code usually located on the back of the credit/debit card to prove his identity. Transaction details such as inventory purchased, purchase amount along with shortened credit data are submitted via secure session to merchant's Web server.

At step 2, data from step 1 is automatically submitted from Merchant to MPS Server.

At step 3, MPS Server will verify both customer and merchant whether they are registered and if there are enough funds to transfer money from customer to merchant. If condition is satisfied, MPS Server will generate random Confirmation Number and send it to customer's mobile phone via SMS message. MPS Server will expect to receive that confirmation number back from merchant within specified time frame to complete transaction.

At step 4, customer will receive SMS message with Confirmation Number. Customer will enter Confirmation Number at Merchant's Web site or send it via SMS message to Merchant. Latter is more secure since in case when intruder can gain access to Merchant's Web site, he additionally needs to intercept confirmation number since it is sent solely from phone. However, by intercepting confirmation number, intruder would not gain anything since confirmation number alone does not provide him credit information nor can he execute transaction since registration with MPS Server is required.

At step 5, Confirmation Number is automatically submitted to MPS Server.

At step 6, MPS Server will verify Confirmation Number submitted to customer's phone with confirmation number received from merchant.

At step 7, if confirmation numbers of step 6 match, MPS Server will transfer funds from customer to merchant and send notifications to both customer and merchant that transaction is complete.

The method illustrated in FIG. 14 uses same approach to make a transaction over the phone as it is done in FIG. 13, with only difference being that merchant and customer will communicate personal/credit data and confirmation number among themselves, where during Web approach it is done automatically.

At step 1, customer provides personal information and shortened credit data to merchant over the phone. At step 2, merchant will manually enter data provided by customer into MPS Server. At step 3, MPS Server will verify customer and merchant registration, check customer's funds, generate random Confirmation number and send it to customer's mobile phone via SMS message. At Step 4, customer will receive Confirmation number in SMS message and will tell that number over the phone to

Merchant. At step 5, merchant will enter Confirmation number into MPS Server manually. At step 6, MPS Server will verify Confirmation Number submitted to customer's phone with Confirmation Number received from merchant. At step 7, if confirmation numbers of step 6 match, MPS Server will transfer funds from customer to merchant and send notifications to both customer and merchant that transaction is complete.

M1 Conclusion: Intruder must have access to both customer's mobile phone and Web or voice connection to gain access to private data. Confirmation number in mobile phone will not give intruder access to credit information. Transactions can only be executed by registered members of MPS Server. Current method does not require customer to have any additional software installed on mobile phone considering SMS is supported.

### METHOD M2

### Mobile Authentication with Encrypted Confirmation Number and Key Received in SMS Using Mobile Phone's Web Browser

M2 Summary: After regular authentication in order to proceed with transaction, customer will request confirmation key using mobile phone. Confirmation number and confirmation key are generated. Confirmation number is encrypted by confirmation key.

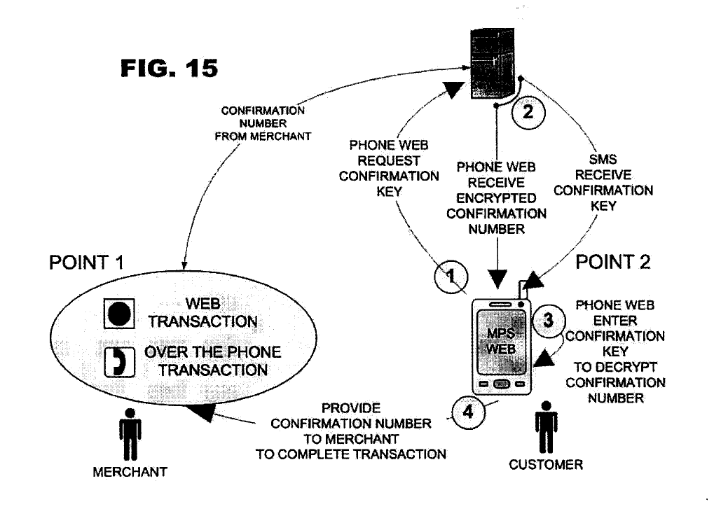

Encrypted confirmation number is sent to mobile phone via http connection. Confirmation key is send to phone via SMS message. Confirmation key is entered to decrypt confirmation number. Confirmation number will be provided by customer to merchant and merchant will use that number to complete transaction. METHOD M2 is more secure than METHOD M1 because if intruder intercepts SMS from server, number in SMS cannot be entered to complete transaction. METHOD M2 has more steps than METHOD M1 since it requires requesting key using mobile phone and typing that key to decrypt confirmation number. Intruder must have access to both customer's mobile phone and Web or voice connection to gain access to private data. Concept is shown in FIG. 15 and it uses technique of TPDS #6.

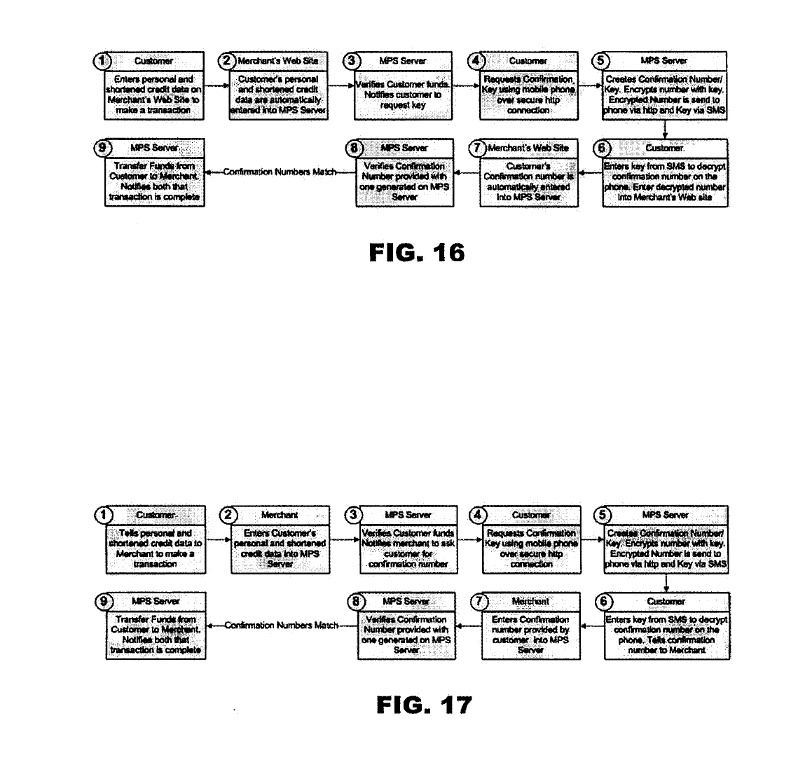

FIG. 16 depicts mobile authentication with encrypted confirmation number and key received in SMS using mobile phone's Web browser preceded by Web authentication. FIG. 17 depicts mobile authentication with encrypted confirmation number and key received in SMS using mobile phone's Web browser preceded by voice authentication. The methods illustrated in both Figures use the same concept to authenticate customer using mobile phones after regular authentication is performed.

FIG. 16 describes 9 steps of Web authentication of METHOD 2:
1. Customer will enter his credentials on merchant's Web site to get authenticated. Regular authentication will be performed on MPS Server via merchant's Web site that will use standardized secure internet session such as SSL over HTTP that will both identify customer and merchant. As per Assumption 1, both customer and merchant are registered with MPS Server. Shortened credit data such as credit card type and last 4 digits of credit card number will be chosen by customer from list of credit accounts registered at MPS Server. Optionally, customer can enter CVV/CVC code usually located on the back of the credit/debit card to prove his identity. Transaction details such as inventory purchased, purchase amount along with shortened credit data are submitted via secure session to merchant's Web server.
2. Data from step 1 is automatically submitted from Merchant to MPS Server.
3. MPS Server will verify both customer and merchant whether they are registered and if there are enough funds to transfer money from customer to merchant. If condition is satisfied, customer will be notified and prompted to use mobile phone to request Confirmation number.
4. Customer will use mobile's phone browser to connect to MPS Server. Customer will enter credentials such as user name/password to authenticate himself on MPS Server. Based on Assumption 1, customer should be registered with MPS Server.
5. MPS Server will generate random Confirmation number and confirmation key. Confirmation number is encrypted by confirmation key. Encrypted confirmation number is sent to mobile phone via http connection. Confirmation key is send to phone via SMS message.
6. Customer will receive SMS with Confirmation key. Encrypted Confirmation number is retrieved from MPS Server via http connection. Confirmation key is entered to decrypt confirmation number. Confirmation number will be entered by customer in merchant's Web site
7. Confirmation Number entered by customer is automatically submitted to MPS Server.
8. MPS Server will verify Confirmation Number stored on server with

Confirmation Number received from merchant's Web site that was entered by customer.
9. If confirmation numbers in step 8 match, MPS Server will transfer funds from customer to merchant and send notifications to both customer and merchant that transaction is complete.

FIG. 17 uses same approach to make a transaction over the phone as is done in FIG. 16, with only difference being that merchant and customer will communicate personal/credit data and confirmation number among themselves, where during Web approach it is done automatically.
1. Customer will tell his personal data to merchant over the phone. Customer will provide accounts he would like to use in a form of Shortened credit data such as credit card type and last 4 digits of credit card number.
2. Merchant will enter customer's personal, shortened credit data and transaction details such as inventory purchased, purchase amount into MPS Server. Per Assumption 1, customer and merchant are both registered with MPS Server.
3. MPS Server will verify both customer and merchant whether they are registered and if there are enough funds to transfer money from customer to merchant. If condition is satisfied, merchant will request customer to provide him Confirmation number.
4. Customer will use mobile's phone browser to connect to MPS Server. Customer will enter credentials such as user name/password to authenticate himself on MPS Server.
5. MPS Server will generate random Confirmation number and confirmation key. Confirmation number is encrypted by confirmation key. Encrypted confirmation number is sent to mobile phone via http connection. Confirmation key is send to phone via SMS message.
6. Customer will receive SMS with Confirmation key. Encrypted Confirmation number is retrieved from MPS Server via http connection. Confirmation key is entered to decrypt confirmation number. Confirmation number will be told by customer to merchant over the phone.
7. Merchant will use Confirmation Number provided by customer to submit to MPS Server to finish transaction
8. MPS Server will verify Confirmation Number stored on server with Confirmation Number received from merchant that was provided by customer.
9. If confirmation numbers in step 8 match, MPS Server will transfer funds from customer to merchant and send notifications to both customer and merchant that transaction is complete.

M2 Conclusion: Intruder must have access to both customer's mobile phone and Web or voice connection to gain access to private data. Confirmation key received in SMS if intercepted will not give intruder ability to proceed with transaction because he needs to use it to derive confirmation number through authorized process on mobile phone, therefore METHOD M2 considered to be more secure than METHOD M1, but requires more steps to make a transaction. Confirmation number in mobile phone if intercepted will not give intruder access to credit information. Transactions can only be executed by registered members of MPS Server. Current method does not require customer to have any additional software installed on mobile phone considering SMS and Web browsing is supported.

### METHOD M3

### Mobile Authentication Via Mobile Phone Application with SMS Confirmation, Public Key and Dynamic Account Exchanges

M3 Summary: After regular authentication, customer will authenticate himself on mobile phone application—MPA and request confirmation number from MPA. One time pin—OTP is either entered by user or automatically created by mobile phone application. Public key will encrypt OTP and send it to server via http connection.

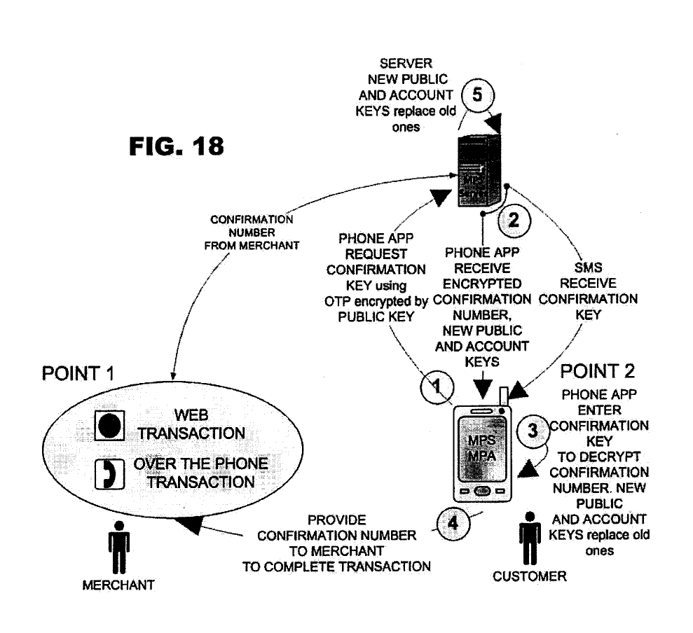

Confirmation number, confirmation key, new public key and new credit account number and key is generated. Confirmation number, new public key and new credit account number and key is encrypted by confirmation key. Encrypted data is sent to mobile phone via http connection. Confirmation key is send to phone via SMS message. Confirmation key is entered to decrypt confirmation data. Confirmation number will be provided by customer to merchant and merchant will use that number to complete transaction. New public key and new credit account number and key will replace old ones on the phone's MPA. METHOD M3 is more secure than METHOD M1 and METHOD M2 because it uses custom application that allows phone authentication, custom encryption of OTP, dynamic exchanges of public keys and credit account numbers. METHOD M3 requires having additional software on mobile phone, while previous methods do not. Intruder must have access to both customer's mobile phone and Web or voice connection to gain access to private data. Concept is shown in FIG. 18 and it uses technique of Two Point Dynamic Solutions method 5.

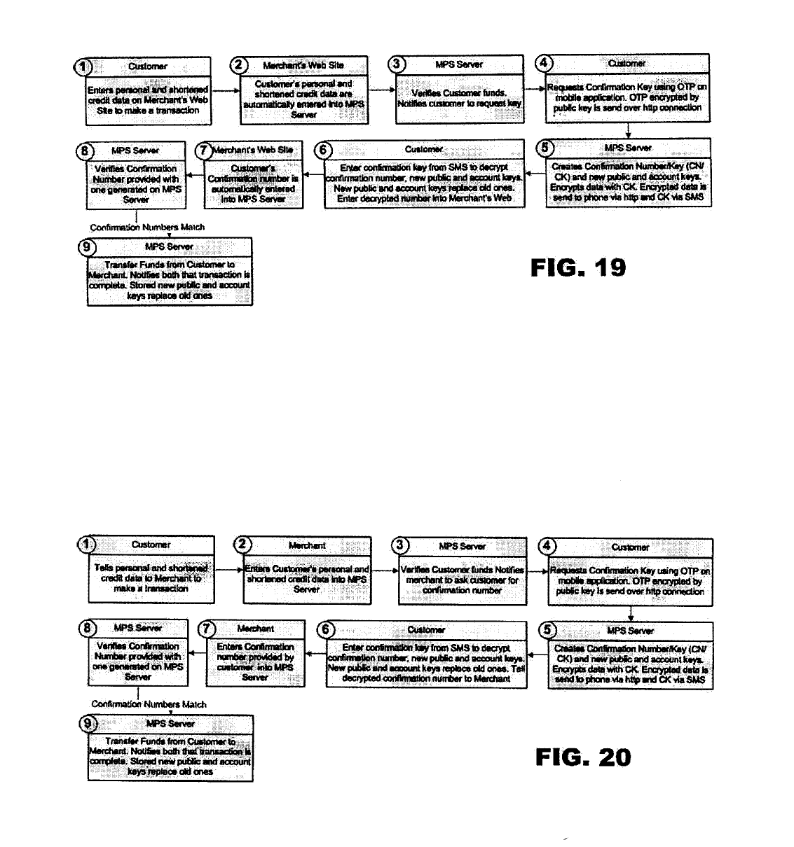

FIG. 19 depicts Mobile authentication via mobile phone application with SMS confirmation, public key and dynamic account exchanges preceded by Web authentication and FIG. 20 depicts Mobile authentication via mobile phone application with SMS confirmation, public key and dynamic account exchanges preceded by voice authentication. The methods illustrated in both Figures use the same concept to authenticate customer using mobile phones after regular authentication is performed.

FIG. 19 has 9 steps to achieve authentication of METHOD 3:
1. Customer will enter his credentials on merchant's Web site to get authenticated.

Regular authentication will be performed on MPS Server via merchant's Web site that will use standardized secure internet session such as SSL over HTTP that will both identify customer and merchant. As per Assumption 1, both customer and merchant are registered with MPS Server. Shortened credit data such as credit card type and last 4 digits of credit card number will be chosen by customer from list of credit accounts registered at MPS Server. Optionally, customer can enter CVV/CVC code usually located on the back of the credit/debit card to prove his identity. Transaction details such as inventory purchased, purchase amount along with shortened credit data are submitted via secure session to merchant's Web server.
2. Data from step 1 is automatically submitted from Merchant to MPS Server.
3. MPS Server will verify both customer and merchant whether they are registered and if there are enough funds to transfer money from customer to merchant. If condition is satisfied, customer will be notified and prompted to use mobile phone to request Confirmation number.
4. Customer will open mobile payment application—MPA. Customer will enter credentials such as PIN to authenticate himself on mobile phone. He will request to get confirmation number and either prompted to create one time pin—OTP or it will be generated by application automatically either as image or in background. Public key that was decrypted by PIN will encrypt OTP and send it to MPS Server over secure http connection.
5. MPS Server will generate random Confirmation number, confirmation key, new public key and new credit account number and key. Confirmation number, new public key and new credit account number and key is encrypted by OTP received from mobile phone and confirmation key. Encrypted confirmation data is sent to mobile phone via http connection. Confirmation key is send to phone via SMS message.
6. Customer will receive SMS with Confirmation key. Encrypted Confirmation data is retrieved from MPS Server via http connection. OTP plus Confirmation key is entered to decrypt confirmation data. If OTP was created by customer it will be re-entered by customer, otherwise, mobile application will retrieve it and append it to confirmation key. Confirmation number from decrypted data will be entered by customer in merchant's Web site. New public key and new credit account number and key from decrypted data will replace old ones in mobile application.
7. Confirmation Number entered by customer is automatically submitted to MPS Server.
8. MPS Server will verify Confirmation Number stored on server with Confirmation Number received from merchant's Web site that was entered by customer.
9. If confirmation numbers in step 8 match, MPS Server will transfer funds from customer to merchant and send notifications to both customer and merchant that transaction is complete. New public key and new credit account number and key stored on server will replace old ones.

FIG. 20 uses same approach to make a transaction over the phone as is done in FIG. 19, with the only difference being that merchant and customer will communicate personal/credit data and confirmation number among themselves, where during Web approach it is done automatically.
1. Customer will tell his personal data to merchant over the phone. Customer will provide accounts he would like to use in a form of Shortened credit data such as credit card type and last 4 digits of credit card number.
2. Merchant will enter customer's personal, shortened credit data and transaction details such as inventory purchased, purchase amount into MPS Server. Per Assumption 1, customer and merchant are both registered with MPS Server.
3. MPS Server will verify both customer and merchant whether they are registered and if there are enough funds to transfer money from customer to merchant. If condition is satisfied, merchant will request customer to provide him Confirmation key.
4. Customer will open mobile payment application—MPA. Customer will enter credentials such as PIN to authenticate himself on mobile phone. He will request to get confirmation number and either prompted to create one time pin—OTP or it will be generated by application automatically either as image or in background. Public key that was decrypted by PIN will encrypt OTP and send it to MPS Server over secure http connection.
5. MPS Server will generate random Confirmation number, confirmation key, new public key and new credit account number and key. Confirmation number, new public key and new credit account number and key is encrypted by OTP received from mobile phone and confirmation key. Encrypted confirmation data is sent to mobile phone via http connection. Confirmation key is send to phone via SMS message.
6. Customer will receive SMS with Confirmation key. Encrypted Confirmation data is retrieved from MPS Server via http connection. OTP plus Confirmation key is entered to decrypt confirmation data. If OTP was created by customer it will be re-entered by customer, otherwise, mobile application will retrieve it and append it to confirmation key. Confirmation number from decrypted data will be entered by customer in merchant's Web site. New public key and new credit account number and key from decrypted data will replace old ones in mobile application.
7. Merchant will use Confirmation Number provided by customer to submit to MPS Server to finish transaction.
8. MPS Server will verify Confirmation Number stored on server with Confirmation Number received from merchant that was provided by customer.
9. If confirmation numbers in step 8 match, MPS Server will transfer funds from customer to merchant and send notifications to both customer and merchant that transaction is complete. New public key and new credit account number and key stored on server will replace old ones.

M3 Conclusion: Intruder must have access to both customer's mobile phone and Web or voice connection to gain access to private data. METHOD M3 is more secure than METHOD M1 and METHOD M2 because it uses custom application that allows phone authentication, custom encryption of OTP, dynamic exchanges of public keys and credit account numbers. METHOD M3 requires having additional software on mobile phone, while previous methods do not.

### METHOD M4

### Mobile Authentication Via Mobile Phone Application with Web Confirmation, Public Key and Dynamic Account Exchanges

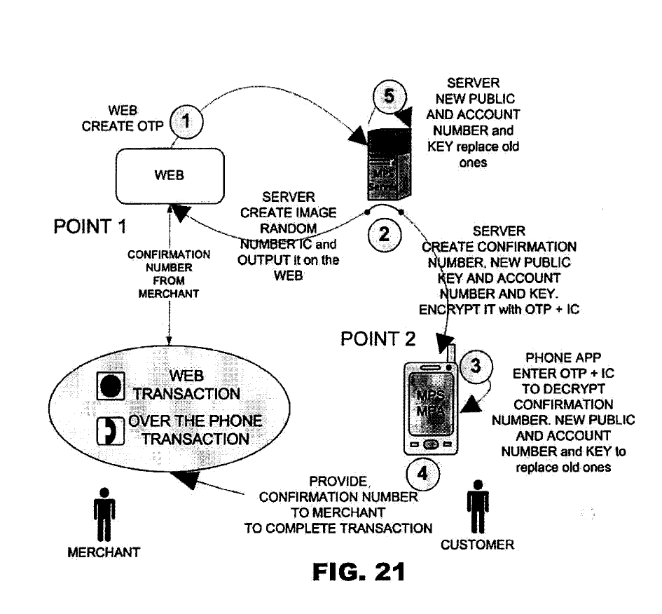

M4 Summary: After regular authentication, customer will create one time pin—OTP on the Web. MPS Server will generate random number labeled Image Code—IC and output IC on Web site. Server will create random confirmation number, new public key and new credit account number and key and encrypt it with combination of OTP and IC. Encrypted data is transferred to phone via http connection or binary SMS. Customer will enter OTP and IC on the phone to decrypt encrypted data. Confirmation number from decrypted data will be provided by customer to merchant and merchant will use that number to complete transaction. New public key and new credit account number and key will replace old ones on the phone's MPA. METHOD M4 is most secure out of all four, because it does not expose dynamic keys since they are not transmitted from points. METHOD M4 requires having additional software on mobile phone. Intruder must have access to both customer's mobile phone and Web or voice connection to gain access to private data. Concept is shown in FIG. 21 and it uses technique of TPDS #1.

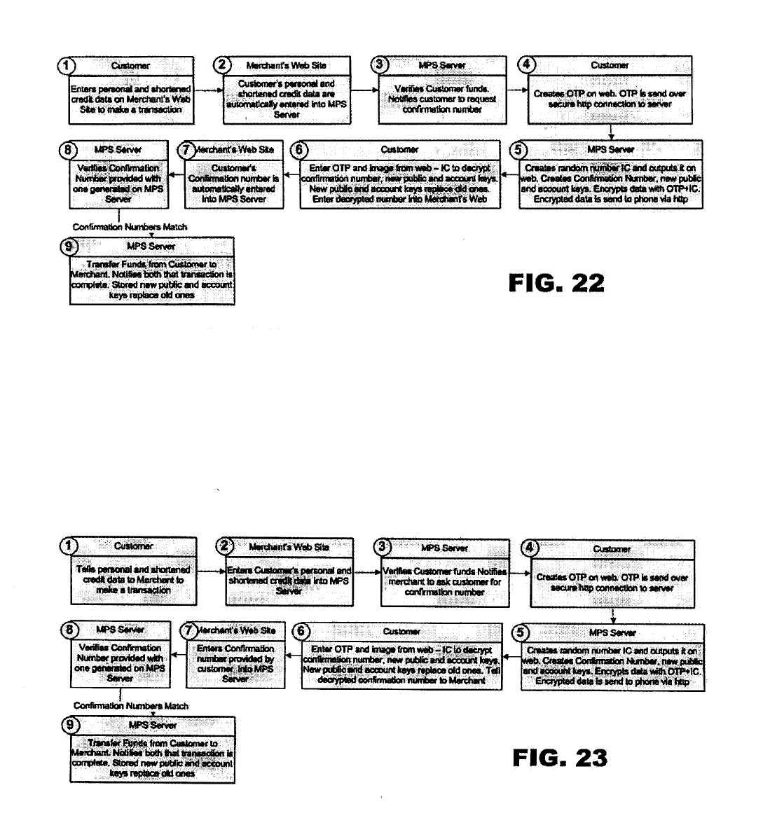

FIG. 22 depicts Mobile authentication via mobile phone application with Web confirmation, public key and dynamic account exchanges preceded by Web authentication and FIG. 23 depicts Mobile authentication via mobile phone application with Web confirmation, public key and dynamic account exchanges preceded by voice authentication. The methods illustrated in both Figures use the same concept to authenticate customer using mobile phones after regular authentication is performed.

FIG. 22 has 9 steps to achieve authentication of METHOD 4:
1. Customer will enter his credentials on merchant's Web site to get authenticated. Regular authentication will be performed on MPS Server via merchant's Web site that will use standardized secure internet session such as SSL over HTTP that will both identify customer and merchant. As per Assumption 1, both customer and merchant are registered with MPS Server. Shortened credit data such as credit card type and last 4 digits of credit card number will be chosen by customer from list of credit accounts registered at MPS Server. Optionally, customer can enter CVV/CVC code usually located on the back of the credit/debit card to prove his identity. Transaction details such as inventory purchased, purchase amount along with shortened credit data are submitted via secure session to merchant's Web server.
2. Data from step 1 is automatically submitted from Merchant to MPS Server.
3. MPS Server will verify both customer and merchant whether they are registered and if there are enough funds to transfer money from customer to merchant. If condition is satisfied, customer will be notified and prompted to use mobile phone to request Confirmation number.
4. Customer will be prompted to create one time password—OTP on the merchant's Web. OTP will be send over secure http connection to MPS Server
5. MPS Server will generate random number, labeled Image Code—IC and output that number IC as image on merchant's Web site for customer to view it. Confirmation number, confirmation key, new public key and new credit account number and key is generated. Confirmation number, new public key and new credit account number and key is encrypted by OTP+IC. Encrypted confirmation data is sent to mobile phone via SMS connection. If no full push technology is available, it will be requested for customer to download encrypted data from mobile phone.
6. Encrypted Confirmation data is received from MPS Server to the phone by either SMS connection or customer requesting it manually in case no push technology is available. OTP created by customer on the merchant's Web plus IC code that is visible on the merchant's Web as number embedded into image is entered to decrypt confirmation data. Confirmation number from decrypted data will be entered by customer in merchant's Web site. New public key and new credit account number and key from decrypted data will replace old ones in mobile application.
7. Confirmation Number entered by customer is automatically submitted to MPS Server.
8. MPS Server will verify Confirmation Number stored on server with Confirmation Number received from merchant's Web site that was entered by customer.
9. If confirmation numbers in step 8 match, MPS Server will transfer funds from customer to merchant and send notifications to both customer and merchant that transaction is complete. New public key and new credit account number and key stored on server will replace old ones.

FIG. 23 uses same approach to make a transaction over the phone as is done in FIG. 19, with the only difference being that merchant and customer will communicate personal/credit data and confirmation number among themselves, where during Web approach it is done automatically.
1. Customer will tell his personal data to merchant over the phone. Customer will provide accounts he would like to use in a form of Shortened credit data such as credit card type and last 4 digits of credit card number.
2. Merchant will enter customer's personal, shortened credit data and transaction details such as inventory purchased, purchase amount into MPS Server. Per Assumption 1, customer and merchant are both registered with MPS Server.
3. MPS Server will verify both customer and merchant whether they are registered and if there are enough funds to transfer money from customer to merchant. If condition is satisfied, merchant will request customer to provide him Confirmation number.
4. Customer will be prompted to create one time password—OTP on the merchant's Web. OTP will be send over secure http connection to MPS Server
5. MPS Server will generate random number, labeled Image Code—IC and output that number IC as image on merchant's Web site for customer to view it. Confirmation number, confirmation key, new public key and new credit account number and key is generated. Confirmation number, new public key and new credit account number and key is encrypted by OTP+IC. Encrypted confirmation data is sent to mobile phone via SMS connection. If no full push technology is available, it will be requested for customer to download encrypted data from mobile phone.
6. Encrypted Confirmation data is received from MPS Server to the phone by either SMS connection or customer requesting it manually in case no push technology is available. OTP created by customer on the merchant's Web plus IC code that is visible on the merchant's Web as number embedded into image is entered to decrypt confirmation data. Confirmation number from decrypted data will be entered by customer in merchant's Web site. New public key and new credit account number and key from decrypted data will replace old ones in mobile application.
7. Merchant will use Confirmation Number provided by customer to submit to MPS Server to finish transaction.
8. MPS Server will verify Confirmation Number stored on server with Confirmation Number received from merchant that was provided by customer.
9. If confirmation numbers in step 8 match, MPS Server will transfer funds from customer to merchant and send notifications to both customer and merchant that transaction is complete. New public key and new credit account number and key stored on server will replace old ones.

Conclusion: Intruder must have access to both customer's mobile phone and Web or voice connection to gain access to private data. METHOD M4 is the most secure method out of previous three since it does not transfer any type of passwords between point one and point two—only encrypted data travels. However, to achieve such security, it requires more steps then three previous methods. Current method requires customer to have custom software installed on mobile phone.

### MPS POI—PAYMENT OVER INTERNET

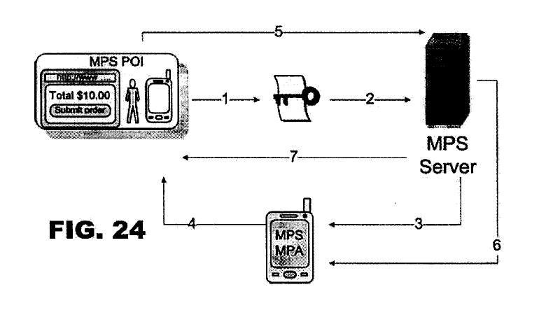

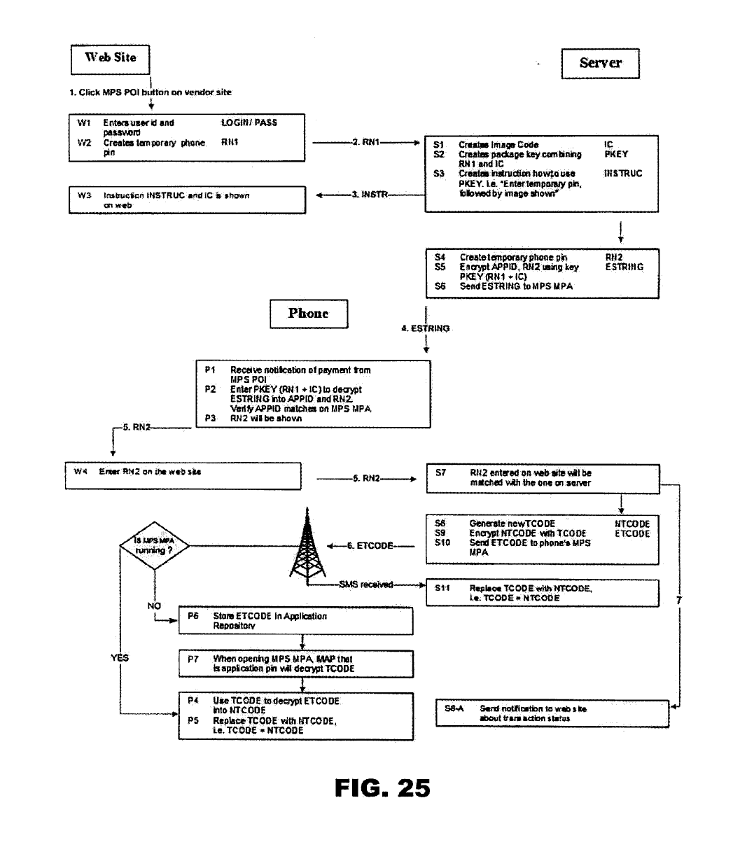

MPS POI or Payment-Over-Internet module can use METHODS M1 through M4 to make transactions. As mentioned earlier, highest security methods will be illustrated in specification. FIG. 24 and FIG. 25 will illustrate very detailed use of METHOD M4 using MPS POI module.
Step 1 Customer will click on MPS POI button as a way of payment on desired Web site and will enter MPS user name and password. MPS can be used as global payment system at merchant's Web site. In this case, user name and password can be entered only once.
Step 2 As in registration, customer will create his own temporary pin—RN1. MPS Server will send back image code—IC to Web site.
Step 3 Server will create random number RN2 and encrypt that by combined RN1 and IC that only customer knows. Encrypted RN2 is send to customer's phone
Step 4 Customer receives notification for payment and enters key that he knows: combined RN1 with IC. When entered correctly, RN2 is shown on the phone. Customer will enter RN2 on Web site to complete transaction
Step 5 Server will compare RN2 entered by customer with the one stored on server and if it matches, server will mark transaction as complete
Step 6 Server will replace TCODE for that account on phone if required
Step 7 Server will send notification to Web site whether transaction was successful

FIG. 25 explains in details how the process works.

MPS POI has the following logic
1. Customer will click on MPS POI button to pay at vendors site
2. Customer will enter username and password of MPS Web site and he will be chosen to create 4 digits temporary pin number—RN1, the same way it was done in registration process in FIG. 3. MPS Server will receive RN1 and create image code—IC, similarly as in registration process. IC will be shown at Web site. MPS Server will combine RN1 and IC into PKEY.

Items in section 2 correspond to steps W1-W2, S1-S2 in FIG. 25.
3. INSTRUC and IC will be shown on Web site for customer to proceed with transaction. It corresponds to steps S3, W3 on FIG. 25. Here is the following example:
   Wait for notification to be received on your phone for payment approval made for ABC Company for x amount. Use temporary PIN you had chosen in previous step, followed by image shown on this Web page. After entering that information on the phone, number will be shown. Use that number to enter in a registration number box below to complete transaction.
4. Server will create RN2 number and encrypt APPID combined with RN2 using PKEY via symmetric encryption. Produced string ESTRING will be send to phone.
   Notes: In case, there is no SMS push is available, customer will be prompted to download ESTRING. In case when public key needs to be replaced, MPS Server will generate public private key pair. Public key will be encrypted as part of ESTRING. When ESTRING will be decrypted, new public key will replace existing one.

Items in section 4 correspond to steps S4-S6 in FIG. 25.
5. Notification on the phone will mention that payment needs to be approved for ABC Company for X amount. Customer will enter RN1 combined with IC and RN2 will be shown on the phone. He will enter RN2 onto Web site to complete payment transaction. RN2 should match the one stored on server.
   Items in section 5 correspond to steps W4, S7 in FIG. 25.
6. In case RN2 matches, account is verified via Payment Authority via MPS BIL module. If verification is successful, Server will need to replace TCODE for that account for which payment transaction was made (if replacement is defined per transaction). Similar to steps 6 and 7 in POS transaction, Server will create NTCODE and encrypt that with TCODE into ETCODE string. ETCODE string will be send to customer's phone MPS MPA. If MPA is not running, phone will store ETCODE in MPS MPA registry. When customer will open MPS MPA and enter mobile application pin—MAP, that pin will decrypt data and retrieve TCODE. In case application is already running, TCODE is available right away. TCODE on the phone in MPS MPA will decrypt ETCODE into NTCODE. Then TCODE will be replaced with NTCODE. MPS Server listens to SMS delivery notifications. In case SMS in item 4 above was delivered successfully, the same TCODE replacement procedure will be performed as in MPS MPA, i.e. TCODE=NTCODE.

Items in section 6 correspond to steps S8-S11, P4-P7 in FIG. 25.
7. When RN2 in step 5 that was entered on Web site matched the one on server, MPS Server will send notification to Web site that transaction complete after account was verified by Payment Authority in step 6
   Notes: If public key is part of ETCODE, new public key will replace old one.

Item in section 7 correspond to step S8-A in FIG. 25.

### Important Notes:

If enabled by policy, GPS coordinates of the phone can be requested by MPS Server by using push notification. When receiving notification, phone can send GPS location details over interne to server to identify unusual shopping patterns.

### MPS POP—PAYMENT OVER THE PHONE

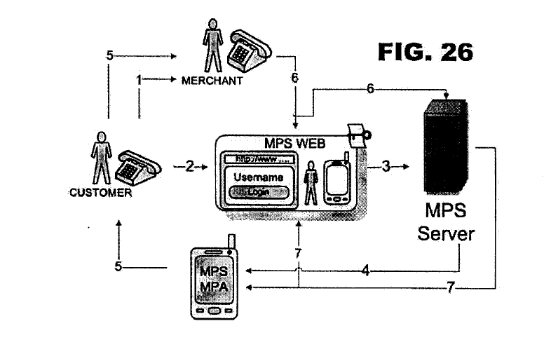

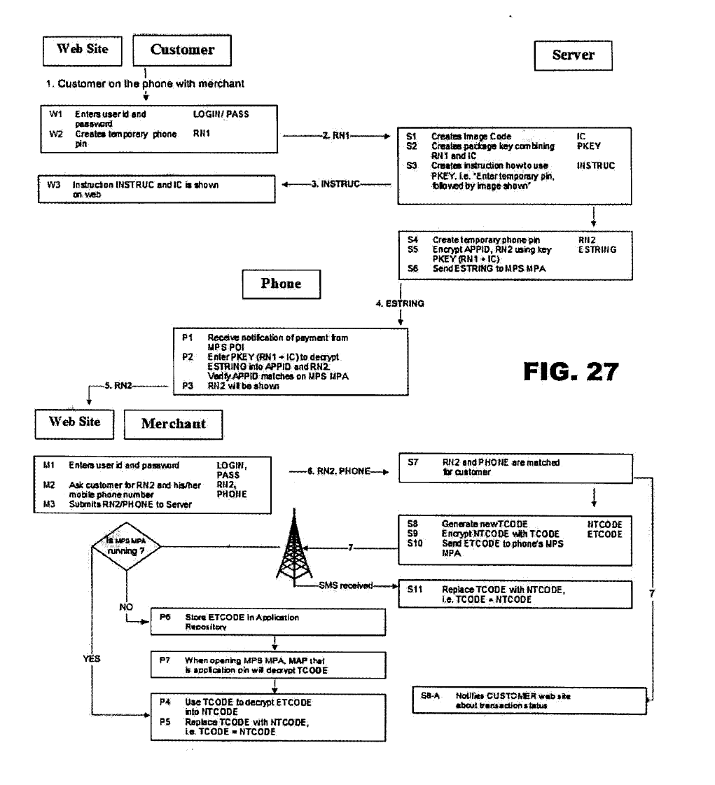

MPS POP or Payment-Over-Phone is designed to make payments over the phone. As in case with MPS POI, MPS POP will use mobile phone as a mean of extra authentication. Concept is similar to MPS POI. FIG. 26 and FIG. 27 illustrate one implementation of METHOD M4, with steps as summarized in TABLE 2 below:

TABLE 2

| | |
|---|---|
| Step | Customer will call merchant to make payment transaction |
| 1 | and notifies that he will desire to make payment via MPS |
| Step | Customer will login into MPS Web site and as in |
| 2 | registration similarly it is done in MPS POI module. |
| | Customer will create temporary pin—RN1. MPS Server |
| | will send back image code—IC to Web site. |
| Step | Server will create random number RN2 and encrypt that |
| 3 | by combined RN1 and IC that only customer knows. |
| Step | Encrypted RN2 is send to customer's phone |
| 4 | |
| Step | Customer receives notification for payment and enters key |
| 5 | that he knows: combined RN1 with IC. When entered |
| | correctly, RN2 is shown on the phone. Customer will tell |
| | merchant RN2 and his/her own mobile phone number. |
| Step | Merchant will login to MPS unless he/she is already |
| 6 | logged in and enter RN2 and mobile phone provided |
| | by customer. |
| Step | Server will authorize or reject transaction, update |
| 7 | TCODE for payment account if required and send |
| | notification to customer's Web site whether transaction |
| | complete or rejected |

FIG. 27 illustrates in detail how this works.

MPS POP has the following logic
1. Customer will call merchant to make a payment and will notify him that he wants to use MPS to make a payment
2. Customer will enter username and password of MPS Web site and he will be chosen to create 4 digits temporary pin number—RN1, the same way it was done in registration process in FIG. 3. MPS Server will receive RN1 and create image code—IC, similarly as in registration process. IC will be shown at Web site. MPS Server will combine RN1 and IC into PKEY.

Items in section 2 correspond to steps W1-W2, S1-S2 in FIG. 27.
3. INSTRUC and IC will be shown on Web site for customer to proceed with transaction. It corresponds to steps S3, W3 on FIG. 27. Here is the following example:
   Wait for notification to be received on your phone for payment approval made for ABC Company for x amount. Use temporary PIN you had chosen in previous step, followed by image shown on this Web page. After entering that information on the phone, number will be shown. Use that number along with your mobile phone number to provide to ABC Company over the phone.
4. Server will create RN2 number and encrypt APPID combined with RN2 using PKEY via symmetric encryption. Produced string ESTRING will be send to phone.
   Notes: In case, there is no SMS push is available, customer will be prompted to download ESTRING. In case when public key needs to be replaced, MPS Server will generate public private key pair. Public key will be encrypted as part of ESTRING. When ESTRING will be decrypted, new public key will replace existing one.

Items in section 4 correspond to steps S4-S6 in FIG. 27.
5. Notification on the phone will mention that payment needs to be approved for ABC Company for X amount. Customer will enter RN1 combined with IC and RN2 will be shown on the phone. He will provide RN2 and his/her own mobile phone number over the phone to merchant.

Items in section 5 correspond to steps P1-P3 in FIG. 27.
6. Merchant will login to MPS Web site that is part of MPS Web module via his username and password and will use customer's mobile phone number and RN2 to complete transaction.

Items in section 6 correspond to steps M1-M3, S7 in FIG. 27.
7. In case RN2 provided by customer matches RN2 stored on the server per mobile phone provided by customer, Server will do the following:
   a. Verify account via Payment Authority via MPS BIL module
   b. MPS Server will send notification to Customer's Web site whether transaction was complete or not
   c. If transaction was completed successfully, Server will need to replace TCODE for that account for which payment transaction was made (if replacement is defined per transaction). Server will create NTCODE and encrypt that with TCODE into ETCODE string. ETCODE string will be send to customer's phone MPS MPA. If MPA is not running, phone will store ETCODE in MPS MPA registry. When customer will open MPS MPA and enter mobile application pin—MAP, that pin will decrypt data and retrieve TCODE. In case application is already running, TCODE is available right away. TCODE on the phone in MPS MPA will decrypt ETCODE into NTCODE. Then TCODE will be replaced with NTCODE. MPS Server listens to SMS delivery notifications. In case SMS in item 4 above was delivered successfully, the same TCODE replacement procedure will be performed as in MPS MPA, i.e. TCODE=NTCODE
   Notes: If public key is part of ETCODE, new public key will replace old one.

Items in section 7 correspond to steps S8-S11, P4-P7, “S8-A” in FIG. 27.

### MPS Web—Updating Accounts, Viewing Transactions

MPS Web is a Web site that allows customer and merchants to work with accounts and transactions. Customers can delete, add, modify, disable and enable accounts, view transactions, remotely erase data on the phone in MPS MPA application, review promotions they are interested in and apply discounts provided by merchants. Merchants can register their merchant accounts, enable MPS POS or MPS PID acquired from MPS, retrieve all transactions per all registered devices, create customer's discounts and perform any other usual activities related to merchant sites.

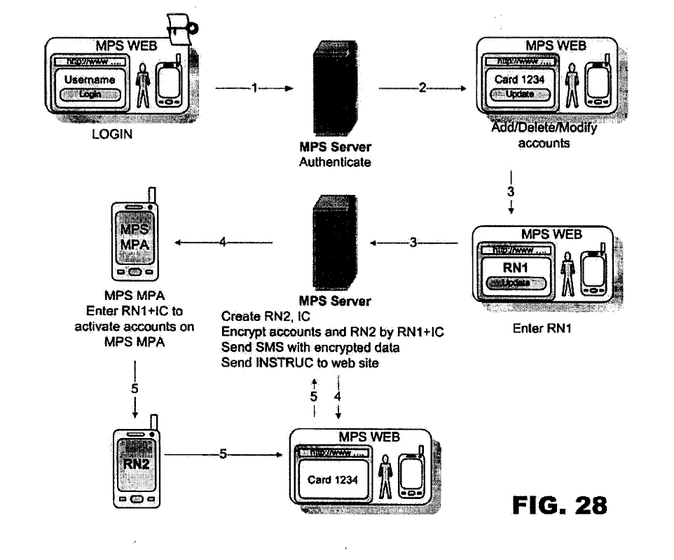

FIG. 28 schematically illustrates the concept. It is functionally very similar to registration process and payments using MPS POI and MPS POP. It is using METHOD 4 to register accounts on mobile phone and server, with steps as summarized in TABLE 3 below:

TABLE 3

| | |
|---|---|
| Step | Customer will login into MPS Web site by entering |
| 1 | MPS user name and password |
| Step | Customer will add/delete/modify accounts |
| 2 | |
| Step | Customer will create temporary pin RN1 to register |
| 3 | above accounts on the phone |
| Step | Server will create random number IC and show it as |
| 4 | image on Web site |
| | Server will create instruction INSTRUC how to register |
| | accounts on the phone and Web site and show that |
| | instructions on Web site |
| | Server will create random number RN2 and encrypt |
| | it along with account descriptions by combined RN1 |
| | and IC that only customer knows. Encrypted data |
| | is send to customer's phone |
| Step | Customer receives notification for account registration |
| 5 | and enters key that he knows: combined RN1 with IC. |
| | When entered correctly, RN2 is shown on the phone |
| | and accounts are registered on the phone. Customer |
| | will enter RN2 on Web site to complete account |
| | registration. Server will compare RN2 entered by |
| | customer with the one stored on server and if it |
| | matches, accounts will be registered on server |

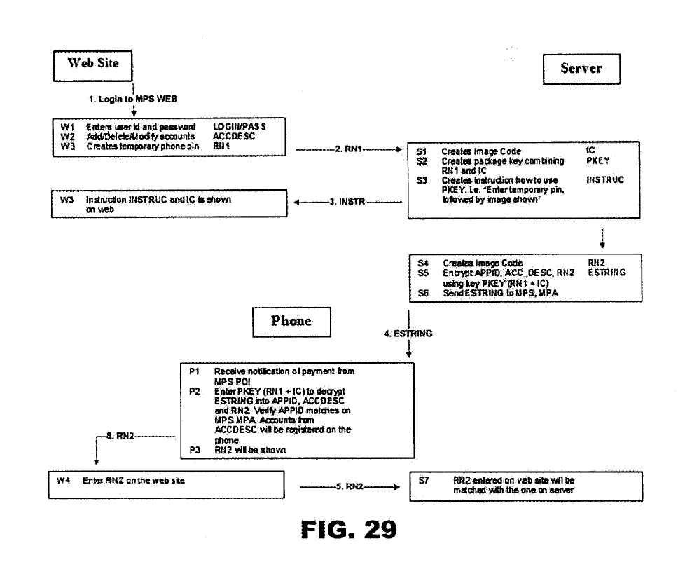

FIG. 29 illustrates the concept in greater detail. MPS Web Account registration steps shown in FIG. 29 are as follows:
1. Customer will open MPS Web site
2. Customer will enter username and password of MPS Web site. He will add/delete/modify accounts. Then, customer will be chosen to create 4 digits temporary pin number—RN1 in order to register accounts—the same way it was done in registration process in FIG. 3. MPS Server will receive RN1 and create image code—IC, similarly as in registration process. IC will be shown at Web site. MPS Server will combine RNI and IC into PKEY.

Items in section 2 correspond to steps W1-W3, S1-S2 in FIG. 29.
3. INSTRUC and IC will be shown on Web site for customer to proceed with registration. It corresponds to steps S3, W3 on FIG. 29. Here is the following example:

Wait for notification to be received on your phone for payment approval made for ABC Company for x amount. Use temporary PIN you had chosen in previous step, followed by image shown on this Web page. After entering that information on the phone, number will be shown. Use that number to enter in a registration number box below to complete transaction.
4. Server will create RN2 number and encrypt APPID, ACCDESC—accounts descriptions combined with RN2 using PKEY via symmetric encryption. Produced string ESTRING will be send to phone.

Notes: In case, there is no SMS push is available, customer will be prompted to download ESTRING.

Items in section 4 correspond to steps S4-S6 in FIG. 29.
5. Notification on the phone will mention that accounts needs to be registered. Customer will enter RN1 combined with IC and RN2 will be shown on the phone. When entered correctly, accounts descriptions ACCDESC will register on the phone. Customer will enter RN2 onto Web site to complete accounts registration. RN2 should match the one stored on server.

Items in section 5 correspond to steps W4, S7 in FIG. 29.

Registration of accounts can be also done on mobile phone. Registering accounts through the phone MPS MPA instead of Web is shown in FIG. 5.

Customer choice for enabling and disabling accounts only requires for customer to login to Web site or call to customer support center and mark account as disabled or enabled. During transaction, MPS Server will only pull active accounts that have no disable flag checked.

In regards to applying coupons, the same approach is used. Customer can apply coupon for his MPS account and during transactions, coupons automatically applied on server. The same true, when customer receives discount onto the phone. In this case coupons secured in the transactions will be verified against coupons on server and if match is found, they will be applied

For merchants, they individually have to contact MPS or qualified vendor. Merchants will need to open Web account with MPS. Then, they will be contacted in order to register each individual MPS POS or MPS PID via certificates and keys and receive POSID for each unit. Certificates and keys will be updates on timely basis remotely using industry standards. Hardware or software updates will be done remotely when required.

### MPS MTM—Money Transfer Module Via Mobile Phones

MPS allows transferring money between customers registered with MPS. In order to transfer money, customers need to be linked with each other first. After successful linkage, customers can transfer money between each other. In terms of security, TPDS methods will be employed. To illustrate concept, the simplest method which is TPDS #7 will be described. However, in reality linkage and money transfer should use more complicated methods of authentication such as method 5, where each user has to individually create OTP and receive confirmation in SMS to approve transaction as in METHOD M3 (that implements method 5)

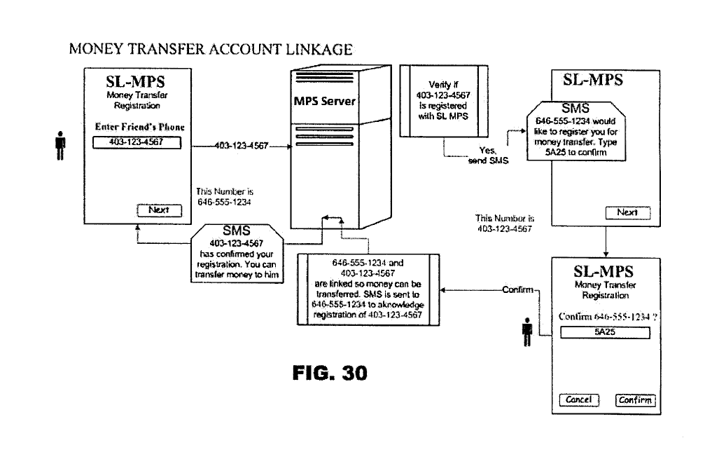

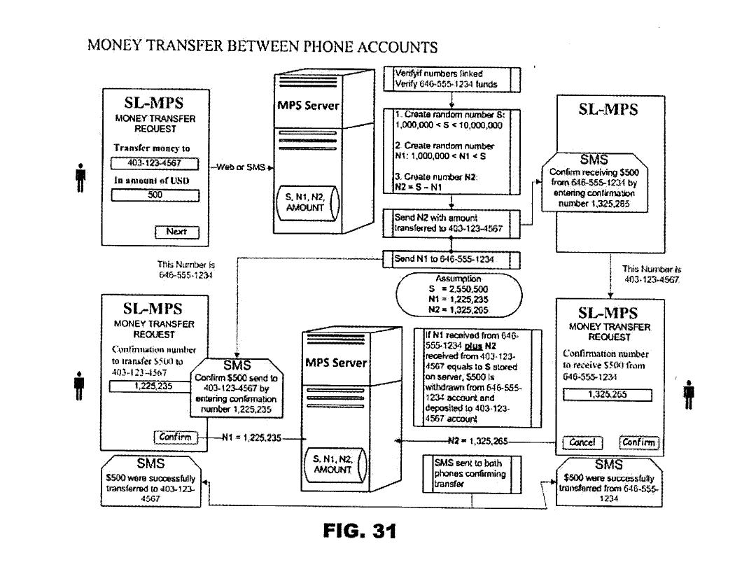

Linkage using method 7 is illustrated in FIG. 30.

Registration or account linkage—means to link Friend 2 to whom Friend 1 may transfer money to.
1. Friend 1 will authenticate into MPS MPA and will enter Friend 2's number to link him. Public key encrypts Friend 2's number and request is sent to MPS Server along with Friend 1's application ID.
2. MPS Server will decrypt Friend 2's number using Friend 1's private key via application ID. MPS Server will verify whether Friend 2's number is already registered with the system.
3. In case Friend 2 is registered, server generates random confirmation number and sends SMS with that number to Friend 2 in order to accept Friend's 1 linkage request.
4. Friend 2 enters confirmation number from SMS. Public key encrypts confirmation number and sends it to server via secure http connection along with Friend 2's application ID. Friend 1's number is downloaded via secure http connection and stored in Friend 2's phone.
5. MPS Server decrypts confirmation number using Friend 2's private key found using application ID. If decrypted confirmation number matches the one on MPS Server, SMS is sent to Friend 1 notifying that Friend 2 has registered with Friend 1 and money transfer transferred is enabled between both Friend 1 and Friend 2. Friend 2's number is stored in the list of registered friends on Friend 1.
   Money transfer using method 7 is shown FIG. 30
   After linkage, you can transfer money between both of you.
1. Friend 1 authenticates in MPS MPA and select amount to transfer, Friend 2's number. Amount and number is encrypted by public key and send along with app ID to MPS Server.
2. MPS Server will decrypt amount and number by Friend 1's private key with app ID.
3. MPS Server will create the following:
   1. Create random number S: 1,000,000<S<10,000,000
   2. Create random number N1: 1,000,000<N1<S
   3. Create number N2: N2=S−Ni
N1 is sent to Friend 1 via SMS, and N2 is sent to Friend 2 via SMS
4. Friend 1 will enter N1 from SMS into mobile application. N1 is encrypted by public key and send along with app ID to MPS Server.
5. Friend 2 will enter N2 from SMS into mobile application. N2 is encrypted by public key and send along with app ID to MPS Server.
6. MPS Server will use app ID of Friend 1 to find private key. Private key will decrypt N1
7. MPS Server will use app ID of Friend 2 to find private key. Private key will decrypt N2
8. N1+N1 retrieved should be equal to S stored on server. If it is, money are transferred between Friend 1 and Friend 2 and customers are notified.
Note: in case of large sums, additionally customer support can call up both you and your friend to verify for additional information.

### MPS—Server Infrastructure

As with any payment transaction systems, MPS deals with customers and merchants personal data that includes private credit information, available funds, etc. As any payment transaction system, MPS must be available 24/7 to ensure smooth transaction processing, must process transaction fast and must be scalable enough to accommodate large volume of transactions. On the other hand, it must be well protected from undesired intrusions. Proper hardware solution is required to run MPS

### Data Center Hardware

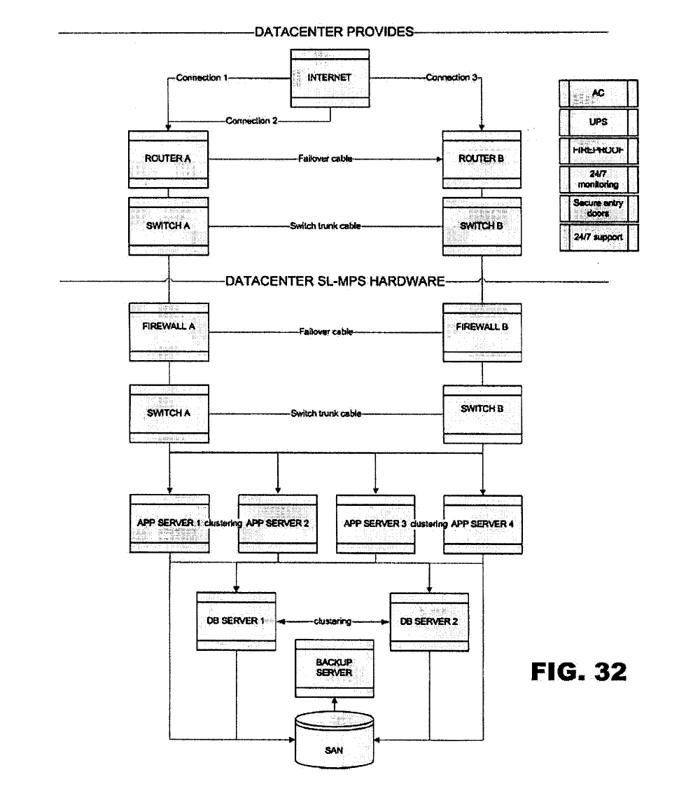

FIG. 32 outlines server hardware architecture required to run MPS Servers

Hardware infrastructure is build in a form of farm or clustering, where scalability achieved by adding new servers to the farm. Switches are responsible to redirect traffic to available servers. In case one of the servers will fail, switch will redirect interne traffic into next available server.

It will be readily appreciated by those skilled in the art that various modifications of the present invention may be devised without departing from the scope and teaching of the present invention, including modifications which may use equivalent structures or materials hereafter conceived or developed. It is to be especially understood that the invention is not intended to be limited to any described or illustrated embodiment, and that the substitution of a variant of a claimed element or feature, without any substantial resultant change in the working of the invention, will not constitute a departure from the scope of the invention. It is also to be appreciated that the different teachings of the embodiments described and discussed herein may be employed separately or in any suitable combination to produce desired results.

In this patent document, any form of the word “comprise” is to be understood in its non-limiting sense to mean that any item following such word is included, but items not specifically mentioned are not excluded. A reference to an element by the indefinite article “a” does not exclude the possibility that more than one of the element is present, unless the context clearly requires that there be one and only one such element.

1: A modular payment system for making payments using a mobile phone, said modular system comprising:
(a) a server;
(b) a web site;
(c) a mobile phone:
(d) a mobile phone application (MPA);
(e) a payment-over-phone module (POP);
(f) point-of-sale (POS) software;
(g) a POS interface device, for processing transactions between the POS software and the server; and
(h) a bank interface, for data communication between the server and a bank;
wherein said system is programmed to initiate a payment only after completion of at least two separate user authentication processes, each occurring at a different location.

2: A modular payment system as in claim 1 wherein the authentication process uses a first dynamic, one-time-use password, generated at a first location.

3: A modular payment system as in claim 2 wherein the first dynamic password is used in conjunction with a second password, generated at a second location, to encrypt or decrypt user information.

4: A modular payment system as in claim 3 wherein the second password is a dynamic, one-time-use password.

5: A modular payment system as in claim 3 wherein the second password is a static, multiple-use password.

6: A modular payment system as in claim 3 wherein:
(a) the first dynamic password is created manually by a user;
(b) an image representing a random number is automatically generated at the first location and displayed on the mobile phone; and
(c) said first dynamic and said image are used in combination to encrypt user data.

7: A modular payment system as in claim 5 wherein:
(a) the first dynamic password is created manually by a user;
(b) the first dynamic password and the static password are used in combination to encrypt user data at the second location.

8: A modular payment system as in claim 5 wherein:
(a) the first dynamic password is created automatically at the first location;
(b) the first dynamic password and the static password are used in combination to encrypt user data at the second location.

9: A modular payment system as in claim 3 wherein:
(a) the first dynamic password is displayed as a representative image;
(b) a confirmation key corresponding to a random number is created automatically at the first location;
(c) the first dynamic password and the confirmation key are used to encrypt user data; and
(d) encrypted data is electronically transferred from the first location to the second location.

10: A modular payment system as in claim 9 wherein the first dynamic password is created automatically and displayed as an image at the first location.

11: A modular payment system as in claim 9 wherein the first dynamic password is created automatically and stored in background at the first location.

12: A modular payment system as in claim 1 wherein:
(a) a first dynamic password is created manually by a user at a first location;
(b) the first dynamic password and the static password are used in combination to encrypt and decrypt user data at a second location;
(c) the first dynamic key and the confirmation key encrypt data at second location; and
(d) encrypted data is transferred from the second location to the first location.

13: A modular payment system as in claim 12 wherein:
(a) an unencrypted confirmation number is generated randomly at the first location and then automatically transmitted to the second location;
(b) the unencrypted confirmation number received at the second location is manually re-entered at the first location.
